(19) United States
(12) Patent Application Publication
(10) Pub. No.: US 2018/0363978 A1
(43) Pub. Date: Dec. 20, 2018

(54) TREATING RAW NATURAL GAS

(71) Applicant: Saudi Arabian Oil Company, Dhahran (SA)

(72) Inventors: Jean-Pierre R. Ballaguet, Dhahran (SA); Milind M. Vaidya, Dhahran (SA); Iran D. Charry-Prada, Dhahran (SA); Sebastien A. Duval, Dhahran (SA); Aadesh Harale, Dhahran (SA); Feras Hamad, Dhahran (SA)

(73) Assignee: Saudi Arabian Oil Company, Dhahran (SA)

(21) Appl. No.: 16/007,585

(22) Filed: Jun. 13, 2018

Related U.S. Application Data
(60) Provisional application No. 62/521,654, filed on Jun. 19, 2017.

(51) Int. Cl. F25J 3/02; B01D 53/22; B01D 71/06; B01D 3/14; C10L 3/10

(52) U.S. Cl. CPC F25J 3/0209; B01D 53/229; B01D 71/06; B01D 3/145; C10L 3/102; C10L 2290/548; F25J 2205/80; F25J 2210/60; F25J 2220/66; F25J 2220/62; F25J 2205/40

(57) ABSTRACT

Techniques for treating a natural gas feed stream include receiving a natural gas feed stream that includes one or more acid gases, one or more hydrocarbon fluids, and one or more non-hydrocarbon fluids; circulating the natural gas feed stream to a membrane module; separating, with the membrane module, at least a portion of the one or more acid gases into a permeate stream and at least a portion of the one or more hydrocarbon fluids into a reject stream; circulating the permeate stream to a distillation unit; and separating, in the distillation unit, the one or more acid gases from the one or more non-hydrocarbon fluids.

### CROSS-REFERENCE TO RELATED APPLICATION

This application claims priority under 35 U.S.C. § 119 to U.S. Provisional Patent Application Ser. No. 62/521,654, filed on Jun. 19, 2017, and entitled “Treating Raw Natural Gas,” the entire contents of which are incorporated by reference herein.

### TECHNICAL FIELD

The present disclosure relates to systems and methods for treating raw natural gas and, more particularly, treating raw natural gas to, for example, separate acid gases, helium, or both.

### BACKGROUND

Natural gas production can often include sour, or acid, gas, which may difficult to treat with existing technologies such as an amine sweetening unit. For instance, for raw natural gas feeds that include a particularly high acid gas content, amine may degrade quickly and generate heat stable salts. Such salts are corrosive and also may cause foaming. Furthermore, raw natural gas feeds that include such high acid gas contents may require more energy for solvent circulation and regeneration (for example, reboiling).

### SUMMARY

In a general implementation, a method of treating a natural gas feed stream includes receiving a natural gas feed stream that includes one or more acid gases, one or more hydrocarbon fluids, and one or more non-hydrocarbon fluids; circulating the natural gas feed stream to a membrane module; separating, with the membrane module, at least a portion of the one or more acid gases into a permeate stream and at least a portion of the one or more hydrocarbon fluids into a reject stream; circulating the permeate stream to a distillation unit; and separating, in the distillation unit, the one or more acid gases from the one or more non-hydrocarbon fluids.

An aspect combinable with the general implementation further includes circulating the permeate stream through a compressor fluidly positioned between the membrane module and the distillation unit; and circulating the reject stream to an amine unit.

Another aspect combinable with any one of the previous aspects further includes separating the one or more hydrocarbon fluids in the reject stream from another portion of the one or more acid gases in the amine unit; and circulating the one or more hydrocarbon fluids to a sales gas pipeline, and circulating the other portion of the one or more acid gases to a sulfur recovery unit (SRU).

In another aspect combinable with any one of the previous aspects, the membrane module includes an acid gas selective membrane that includes at least one of a poly-imide (PI) membrane, a cellulose acetate (CA) membrane, or an amorphous perfluoropolymer membrane.

In another aspect combinable with any one of the previous aspects, the distillation unit includes a bottom output that outputs the portion of the one or more acid gases and an overhead output that outputs the one or more non-hydrocarbon fluids.

Another aspect combinable with any one of the previous aspects further includes circulating the one or more non-hydrocarbon fluids to a power generation unit, and circulating the portion of the one or more acid gases to the SRU; and circulating the one or more non-hydrocarbon fluids to a second membrane module fluidly coupled between the overhead output and the amine unit.

In another aspect combinable with any one of the previous aspects, the second membrane module includes another acid gas selective membrane that includes at least one of a PI membrane, a CA membrane, or an amorphous perfluoropolymer membrane.

Another aspect combinable with any one of the previous aspects further includes separating, with the second membrane module, another portion of the one or more acid gases entrained in the one or more non-hydrocarbon fluids; circulating the separated portion of the one or more acid gases to the SRU, and circulating the one or more non-hydrocarbon fluids to at least one of the amine unit or the power generation unit; and circulating the separated one or more non-hydrocarbon fluids to a third membrane module.

In another aspect combinable with any one of the previous aspects, the third membrane module includes a helium selective membrane that includes a PI helium selective membrane.

Another aspect combinable with any one of the previous aspects further includes separating a helium fluid from the one or more non-hydrocarbon fluids with the third membrane module; and recovering the separated helium fluid in a helium recovery unit that is fluidly coupled to the third membrane module.

In another aspect combinable with any one of the previous aspects, the distillation unit includes a hydrogen sulfide (H₂S) distillation unit.

Another aspect combinable with any one of the previous aspects further includes separating, in the H₂S distillation unit, a stream of H₂S from the one or more acid gases; and circulating the stream of H₂S to the SRU, and circulating an H₂S-lean stream of the one or more acid gases to another distillation unit.

In another aspect combinable with any one of the previous aspects, the other distillation unit includes a carbon dioxide (CO₂) distillation unit.

Another aspect combinable with any one of the previous aspects further includes separating, in the other distillation unit, a stream of CO₂ from the H₂S-lean stream; circulating the stream of CO₂ away from the other distillation unit, and circulating a CO₂-lean stream from the other distillation unit to a second membrane module; separating, in the second membrane module, at least a portion of a helium fluid from the CO₂-lean stream; circulating the portion of the helium fluid to a third membrane module, and circulating a helium-lean stream from the second membrane module; and separating another portion of the helium fluid, in the third membrane module.

In another aspect combinable with any one of the previous aspects, the one or more acid gases includes at least one of H₂S or CO₂.

In another general implementation, a natural gas processing system includes a first membrane module positioned to receive a natural gas feed stream that includes one or more acid gases, one or more hydrocarbon fluids, and one or more non-hydrocarbon fluids, the first membrane module configured to separate at least a portion of the one or more acid gases into a permeate stream and at least a portion of the one or more hydrocarbon fluids into a reject stream; a distillation unit in fluid communication with the first membrane; and a control system configured to perform operations. The operations include circulating the natural gas feed stream to the first membrane module; circulating the permeate stream separated by the first membrane module to the distillation unit; and operating the distillation unit to separate, in the distillation unit, the one or more acid gases from the one or more non-hydrocarbon fluids.

In an aspect combinable with the general implementation, the control system is configured to perform operations further including circulating the permeate stream through a compressor fluidly positioned between the membrane module and the distillation unit; and circulating the reject stream to an amine unit.

In another aspect combinable with any one of the previous aspects, the control system is configured to perform operations further including separating the one or more hydrocarbon fluids in the reject stream from another portion of the one or more acid gases in the amine unit; circulating the one or more hydrocarbon fluids to a sales gas pipeline; and circulating the other portion of the one or more acid gases to a sulfur recovery unit (SRU).

In another aspect combinable with any one of the previous aspects, the first membrane module includes an acid gas selective membrane that includes at least one of a poly-imide (PI) membrane, a cellulose acetate (CA) membrane, or an amorphous perfluoropolymer membrane.

In another aspect combinable with any one of the previous aspects, the distillation unit includes a bottom output and an overhead output.

In another aspect combinable with any one of the previous aspects, the control system is configured to perform operations further including circulating the portion of the one or more acid gases from the bottom output; circulating the one or more non-hydrocarbon fluids from the overhead output; circulating the one or more non-hydrocarbon fluids to a power generation unit; circulating the portion of the one or more acid gases to the SRU; and circulating the one or more non-hydrocarbon fluids to a second membrane module fluidly coupled between the overhead output and the amine unit.

In another aspect combinable with any one of the previous aspects, the second membrane module includes another acid gas selective membrane that includes at least one of a PI membrane, a CA membrane, or an amorphous perfluoropolymer membrane.

In another aspect combinable with any one of the previous aspects, the control system is configured to perform operations further including operating the second membrane module to separate another portion of the one or more acid gases entrained in the one or more non-hydrocarbon fluids; circulating the separated portion of the one or more acid gases to the SRU; circulating the one or more non-hydrocarbon fluids to at least one of the amine unit or the power generation unit; and circulating the separated one or more non-hydrocarbon fluids to a third membrane module.

In another aspect combinable with any one of the previous aspects, the third membrane module includes a helium selective membrane that includes a PI helium selective membrane.

In another aspect combinable with any one of the previous aspects, the control system is configured to perform operations further including operating the third membrane module to separate a helium fluid from the one or more non-hydrocarbon fluids with the third membrane module; and recovering the separated helium fluid in a helium recovery unit that is fluidly coupled to the third membrane module.

In another aspect combinable with any one of the previous aspects, the distillation unit includes a hydrogen sulfide (H₂S) distillation unit.

In another aspect combinable with any one of the previous aspects, the control system is configured to perform operations further including operating the H₂S distillation unit to separate a stream of H₂S from the one or more acid gases; and circulating the stream of H₂S to the SRU; and circulating an H₂S-lean stream of the one or more acid gases to another distillation unit.

In another aspect combinable with any one of the previous aspects, the other distillation unit includes a carbon dioxide (CO₂) distillation unit.

In another aspect combinable with any one of the previous aspects, the control system is configured to perform operations further including operating the other distillation unit to separate a stream of CO₂ from the H₂S-lean stream; circulating the stream of CO₂ away from the other distillation unit; circulating a CO₂-lean stream from the other distillation unit to the second membrane module; operating a second membrane module to separate at least a portion of a helium fluid from the CO₂-lean stream; circulating the portion of the helium fluid to a third membrane module; circulating a helium-lean stream from the second membrane module; and operating the third membrane module to separate another portion of the helium fluid.

In another aspect combinable with any one of the previous aspects, the one or more acid gases includes at least one of H₂S or CO₂.

Implementations according to the present disclosure may include one or more of the following features. For example, implementations according to the present disclosure may facilitate the separation of acid gases (for example, hydrogen sulfide (H₂S) and carbon dioxide (CO₂)) from a raw natural gas feed stream while minimizing slippage of heavy hydrocarbons (HHC), a loss of methane, and energy use. As another example, implementations according to the present disclosure may minimize the HHC content of a feed of a reaction furnace of a sulfur recovery unit (SRU). Also, implementations according to the present disclosure may upgrade sour gas through a utilization of membranes of different selectivity, which can be advantageously utilized upstream of one or more distillation units to concentrate the acid gas percentage being fed to the distillation unit in order to maximize separation efficiency. As another example, implementations according to the present disclosure may increase an efficiency of a Claus unit through higher H₂S concentration in feed to an SRU and smoother operability of the SRU. Further, implementations according to the present disclosure may avoid or help avoid Carsul formation due to an absence or reduction of HHC in a feed to the SRU. Further, implementations according to the present disclosure may route rich H₂S from the distillation unit to a reservoir for re-injection. Also, implementations according to the present disclosure may allow for the recovery of HHC while still separating acid gases, unlike conventional techniques.

Implementations according to the present disclosure may also include one or more of the following features. For example, implementations according to the present disclosure may recovery helium from sour natural gas that can be further monetized after enrichment steps. For example, helium can be further concentrated and recovered by membranes and a helium recovery unit. As another example, implementations according to the present disclosure may reduce acid gases to an amine unit while preventing HHC to be in the bottoms of distillations. Thus, bottoms of distillation units can be directly sent to a reaction furnace of an SRU with a reduced risk of contamination of catalytic beds. As another example, additional revenues may be realized by recovery of HHC according to the described implementations. Further, present implementations may avoid circulating the HHC to the SRU or for reinjection.

The details of one or more implementations of the subject matter described in this disclosure are set forth in the accompanying drawings and the description. Other features, aspects, and advantages of the subject matter will become apparent from the description, the drawings, and the claims.

### BRIEF DESCRIPTION OF THE DRAWINGS

FIG. 1A shows a schematic illustration of an example implementation of a hybrid raw natural gas treatment system and process that uses a membrane and a distillation unit to separate acid gases from natural gas according to the present disclosure.

FIGS. 1B-1C illustrate results of a simulation of the hybrid raw natural gas treatment system and process shown in FIG. 1A that uses one or more poly-imide (PI) membranes.

FIGS. 1D-1E illustrate results of another simulation of the hybrid raw natural gas treatment system and process shown in FIG. 1A that uses one or more cellulose acetate (CA) membranes.

FIGS. 1F-1G illustrate results of a simulation of the hybrid raw natural gas treatment system and process shown in FIG. 1A that uses one or more Hyflon AD-80 (amorphous perfluoropolymers) membranes.

FIG. 2A shows a schematic illustration of another example implementation of a hybrid raw natural gas treatment system and process that uses two membranes and a distillation unit to separate acid gases from natural gas according to the present disclosure.

FIGS. 2B-2C illustrate results of a simulation of the hybrid raw natural gas treatment system and process shown in FIG. 2A.

FIG. 3A shows a schematic illustration of another example implementation of a hybrid raw natural gas treatment system and process that uses two membranes and a distillation unit to separate acid gases from natural gas according to the present disclosure.

FIGS. 3B-3C illustrate results of a simulation of the hybrid raw natural gas treatment system and process shown in FIG. 3A.

FIG. 4A shows a schematic illustration of another example implementation of a hybrid raw natural gas treatment system and process that uses two membranes and a distillation unit to separate acid gases from natural gas, as well as a membrane and a helium recovery unit to capture helium from natural gas according to the present disclosure.

FIGS. 4B-4D illustrate results of a simulation of the hybrid raw natural gas treatment system and process shown in FIG. 4A.

FIG. 5A shows a schematic illustration of another example implementation of a hybrid raw natural gas treatment system and process that uses one or more membranes and cascading distillation units to separate acid gases from natural gas and capture helium according to the present disclosure.

FIGS. 5B-5Q illustrate results of a simulation of the hybrid raw natural gas treatment system and process shown in FIG. 5A.

### DETAILED DESCRIPTION

The present disclosure describes example implementations of a raw natural gas treatment system and process in which membrane and distillation processes are combined to minimize slippage of heavy hydrocarbons (HHC) while separating acid gases (for example, H₂S and CO₂) from a raw natural gas stream. In some aspects, acid gas selective membranes are implemented for bulk removal of acid gases from raw natural gas. The output of implementing the membrane system and process may include two streams: a reject stream that has a relatively high concentration of HHC and a relatively low concentration of acid gases, and a permeate stream that has a relatively low concentration of HHC and a relatively high concentration of acid gases. The reject stream may be routed to an amine unit and subsequently to a refrigeration unit to recover the HHC after gas sweetening and dehydration. The permeate stream may be compressed and circulated to one or more a distillation units where acid gas removal is implemented leaving other gases (for example, methane, helium, and nitrogen) in an overhead of the distillation column. Thus, a membrane system and process and a distillation system and process may be combined to generate an acid gas stream depleted in HHC. The acid gases can be separated from the acid gas stream by distillation, while the HHC can be recovered using refrigeration after gas sweetening and dehydration.

In some aspects, by combining membrane and distillation sub-processes in the hybrid raw natural gas treatment system and process, lowering acid gases in a stream that enters an amine unit may also minimize HHC loss in the distillation bottom stream, which in turn may reduce HHC in the feed of a sulfur recovery unit (SRU). Further, in some aspects, helium in the stream may be concentrated in the distillation unit overhead, which may be economically recovered as pure helium in a dedicated unit after enrichment steps. In some aspects, an outlet temperature of the one or more distillation units may be about −30° C., which may enable higher selectivity for the membrane(s) to separate compounds from the overhead of the distillation column.

In example implementations, two membrane stages may be used to reduce a content of the acid gases in the raw natural gas stream. Further, implementations according to the present disclosure may include a reduced temperature of a stream circulated to a second stage membrane section to provide for increased selectivity for the second stage or subsequent membrane section. Additionally, the example implementations of the raw natural gas treatment system and process may include the recovery and enrichment of helium in the overhead of the distillation unit(s). Also, such implementations may generate an increased nitrogen content than the feed in the overhead of the distillation unit.

In some aspects, bulk removal of acid gas from raw natural gas can be performed with the help of acid gas selective membrane. For example, example processes may include one or multiple stages of membrane separation, as well as one or more distillation stages. In some aspects, glassy polymeric membranes are utilized to separate raw natural gas components from a high pressure acid gas stream into two streams: one at high pressure stream (or reject) and one at low pressure stream (or permeate). For glassy polymers, small molecules are faster than bigger molecules to permeate; separation is mainly due to size of molecules. Hence, helium, water, hydrogen sulfide, carbon dioxide, and nitrogen will permeate faster than C2+. Therefore, the permeate gas stream, depleted in HHC, can be routed to a distillation unit, where acid gas removal is carried out, while methane, helium and nitrogen remain in the overhead of the distillation unit.

In example implementations, the permeate stream (low pressure stream) is concentrated in acid gas while depleted in HHC so it can be liquefied without significant loss of HHC. A reject stream (high pressure stream) is depleted in acid gas. This high pressure stream can be treated in an existing or new high pressure amine unit. Subsequently, HHC can be recovered from this high pressure stream with the help of a refrigeration unit after gas sweetening and dehydration steps. The permeate stream at low pressure (for example, between 50-250 pounds per square inch (psi)), which may contain relatively small amounts of HHC, can be efficiently treated in a high pressure distillation column to concentrate acid gas in the bottom and recover methane and other gases from the overhead. Acid gases and water are concentrated in the bottom of the distillation column and can be routed to the reaction furnace of the SRU. The overhead product, which may be mainly methane, could be used as fuel or directed to a master gas system after a final sweetening step if necessary depending on the distillation performance and gas composition.

In some aspects, the example processes may produce an acid gas stream depleted in HHC that can be directly routed to the reaction furnace of the SRU and avoid the loss of valuable HHC. In contrast to conventional techniques, the example implementations may facilitate a large fraction of acid gases being separated from a natural gas feed with minimal loss of HHC. Further, implementations that include helium recovery, for example, with helium selective membrane(s) installed downstream of one or more distillation units such membranes receive a gas containing a much lower content of acid gas and HHC, which results in longer lifetime and improved separation performance of the membranes.

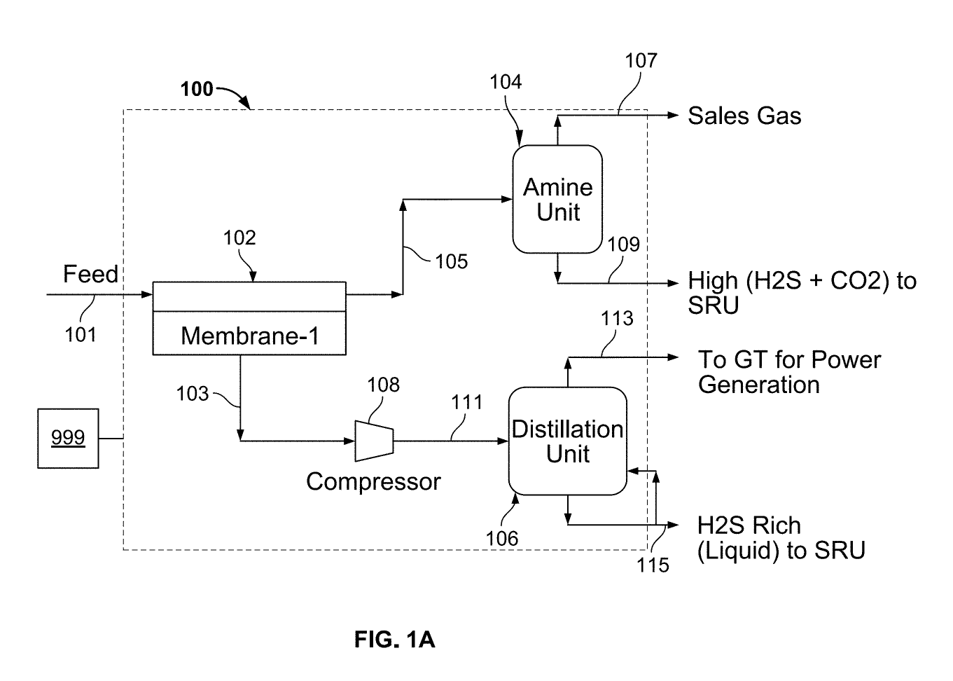

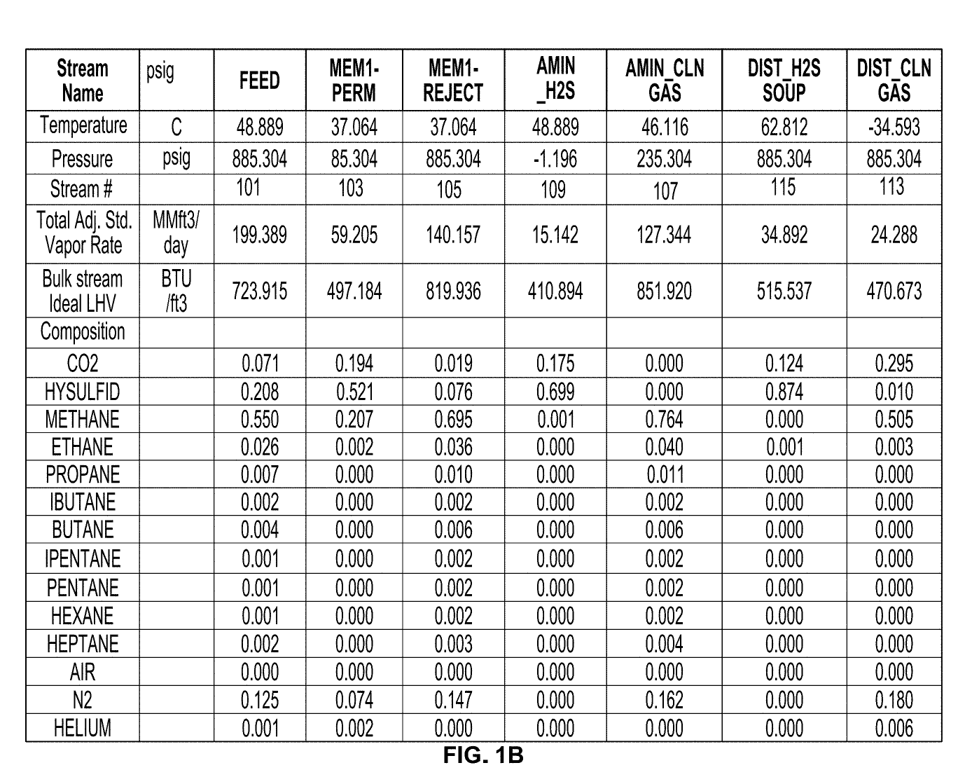

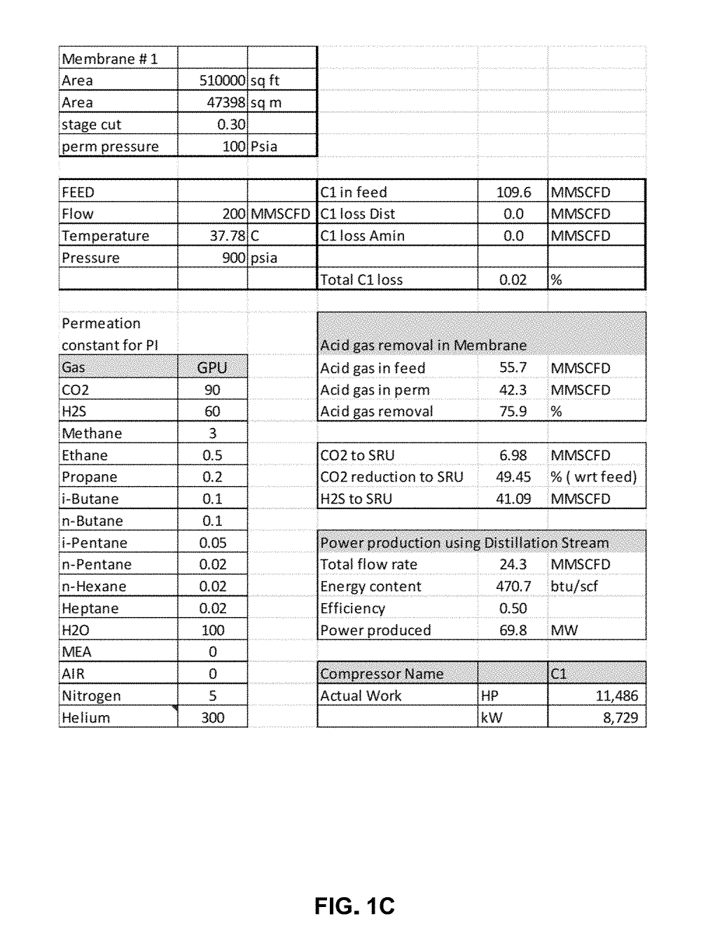

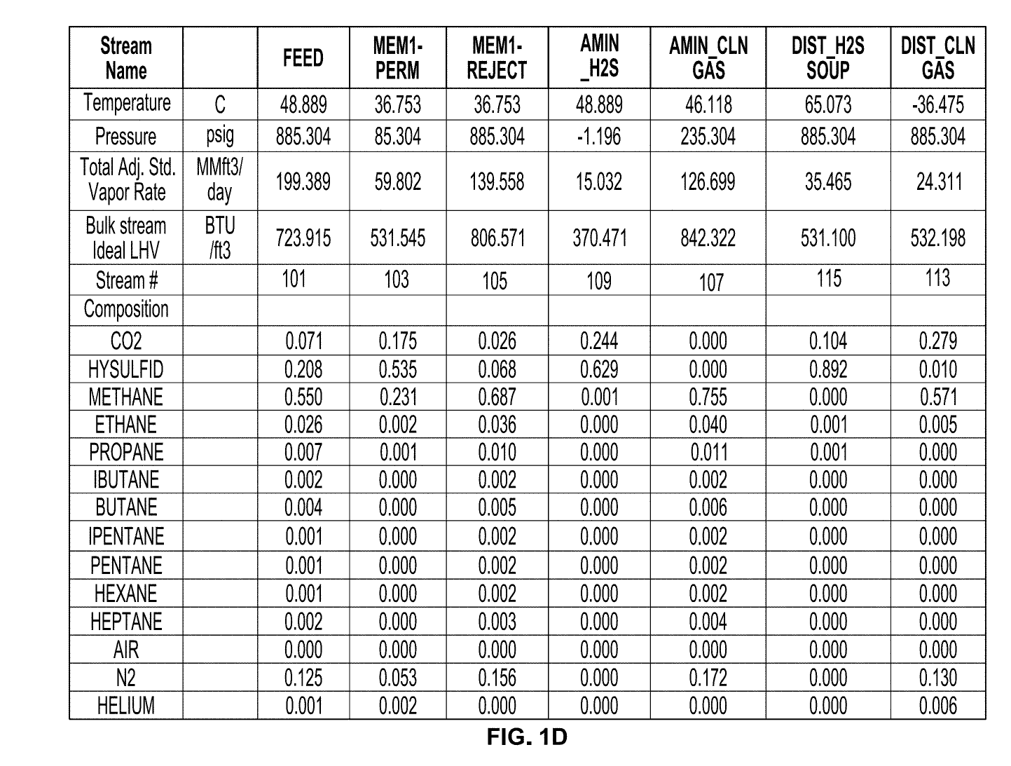

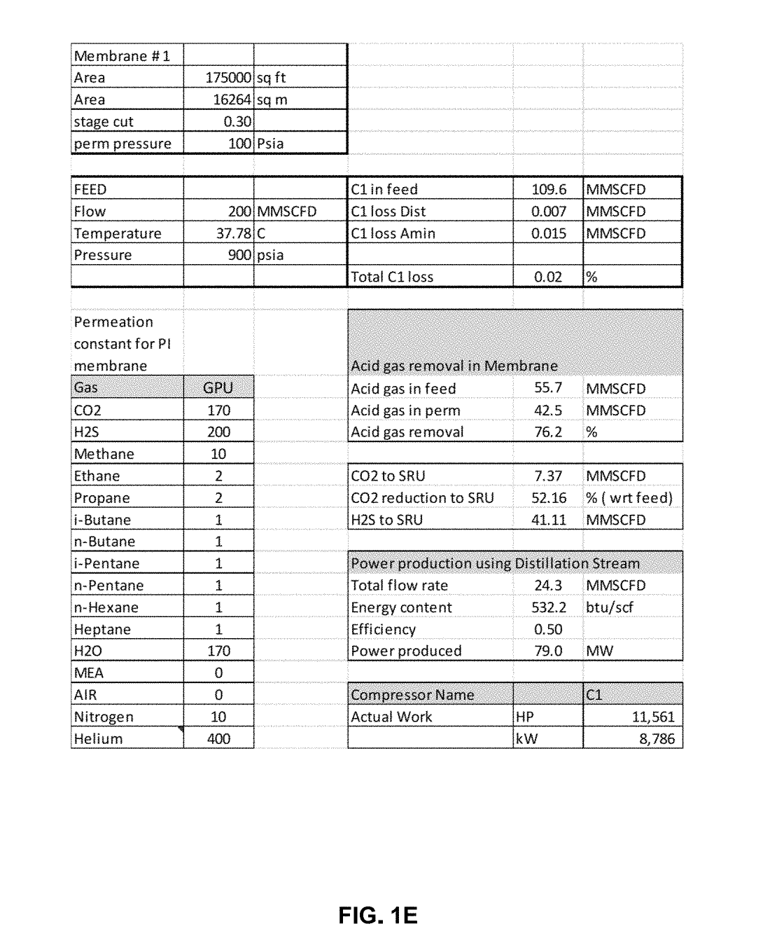

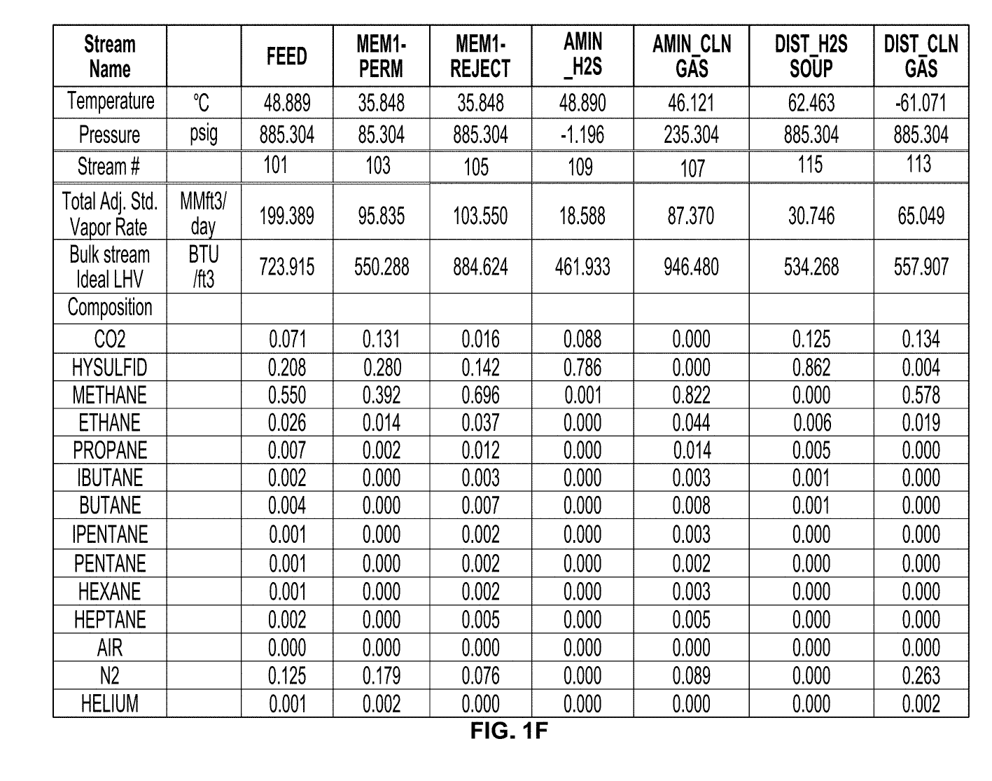

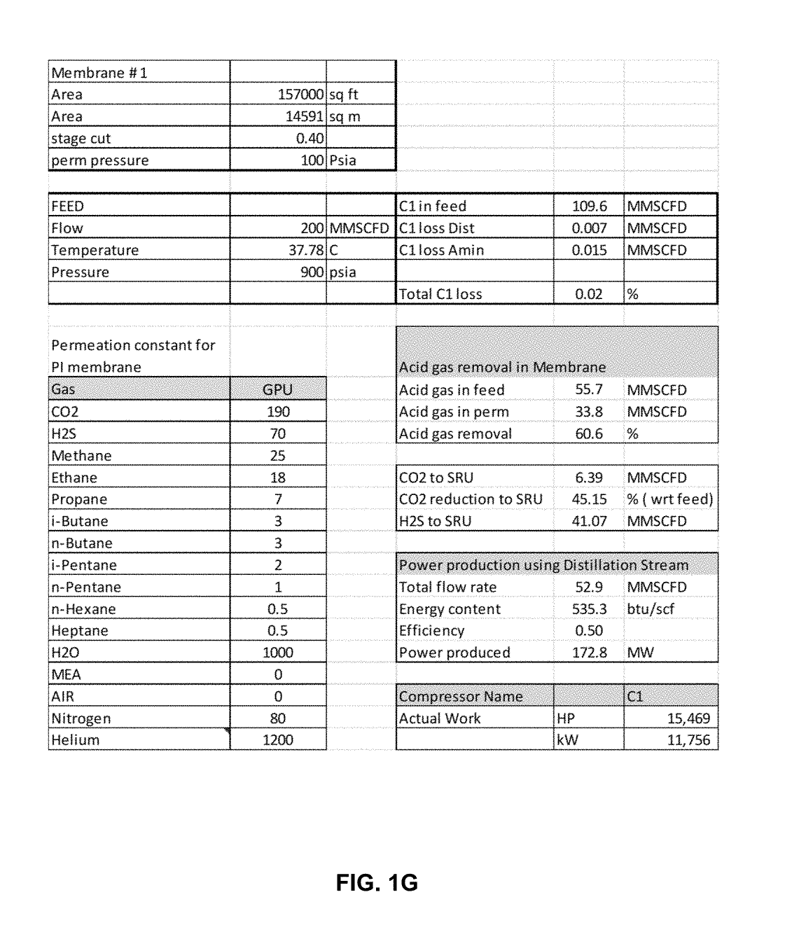

FIG. 1A shows a schematic illustration of an example implementation of a hybrid raw natural gas treatment system 100 that uses a membrane and a distillation unit to separate acid gas from natural gas. In this illustrated implementation, the system 100 includes a membrane 102 that receives a raw natural gas feed stream 101. In some aspects, the natural gas feed stream 101 is at a flow rate of between 5 and 500 million standard cubic feet per day (MMscfd). The membrane 102 separates the natural gas feed stream 101 into a permeate stream 103 that flows through a compressor 108 to a distillation unit 106 and a reject stream 105 that flows to an amine unit 104. The permeate stream 103 has a relatively low concentration of HHC and a relatively high concentration of acid gases compared to the reject stream 105, which has a relatively low concentration of acid gases and a relatively high concentration of HHC. The membrane 102 may be or include, for example, a PI membrane, a CA membrane, or a Hyflon AD-80 (amorphous perfluoropolymers) membrane. Thus, the membrane 102 may be selected to ensure that acid gases (for example, H₂S and CO₂) are separated from HHC (for example, due to a material of the membrane 102).

The permeate stream 103, which may be at a lower pressure than the reject stream 105, is compressed into a compressed permeate stream 111 that is circulated to the distillation unit 106, in which the acid gases (and possibly a small portion of HHC not separated in the membrane 102) are separated in a bottom stream 115 of the distillation unit 106 from other gases (for example, helium (He), water (H₂O) and nitrogen (N₂)) in an overhead stream 113 of the unit 106. The other gases may be circulated to the gas turbine (GT) for power generation, while the acid gases (and portion of HHC) may be circulated to the SRU.

The reject stream 105, which may be at a higher pressure than the permeate stream 103, is circulated to the amine unit 104, in which sales gas 107 is separated from the remaining acid gases 109 in the reject stream 105. The separated acid gases 109 may also be circulated to the SRU. In some aspects, the sales gas 107 may be circulated to a refrigeration unit for recovery of the HHC.

FIGS. 1B-1C illustrate results of a simulation of the hybrid raw natural gas treatment system and process shown in FIG. 1A that uses one or more poly-imide (PI) membranes. The simulation from which the results shown in FIGS. 1B-1C (as well as the other simulations shown and described in the present disclosure) were performed using PRO II and HYSIS modeling software, as well as data available for the particular types of membranes and distillation units described in the disclosure. FIGS. 1B-1C show simulations of the system 100 in which the membrane 102 is a PI membrane, as well as mass balance (dry basis) for the system 100. FIGS. 1B-1C also show data regarding the membrane 102, permeation constant for the membrane 102, the acid gases removed by the membrane 102, and the power production using the overhead stream from distillation unit 106.

FIGS. 1D-1E illustrate results of another simulation of the hybrid raw natural gas treatment system and process shown in FIG. 1A that uses one or more cellulose acetate (CA) membranes. FIGS. 1D-1E show simulations of the system 100 in which the membrane 102 is the CA membrane, as well as mass balance (dry basis) for the system 100. FIGS. 1D-1E also show data regarding the membrane 102, permeation constant for the membrane 102, the acid gases removed by the membrane 102, and the power production using the overhead stream from distillation unit 106.

FIGS. 1F-1G illustrate results of a simulation of the hybrid raw natural gas treatment system and process shown in FIG. 1A that uses one or more Hyflon AD-80 (amorphous perfluoropolymers) membranes. FIGS. 1F-1G show simulations of the system 100 in which the membrane 102 is the Hyflon AD-80 membrane, as well as mass balance (dry basis) for the system 100. FIGS. 1F-1G also show data regarding the membrane 102, permeation constant for the membrane 102, the acid gases removed by the membrane 102, and the power production using the overhead stream from distillation unit 106.

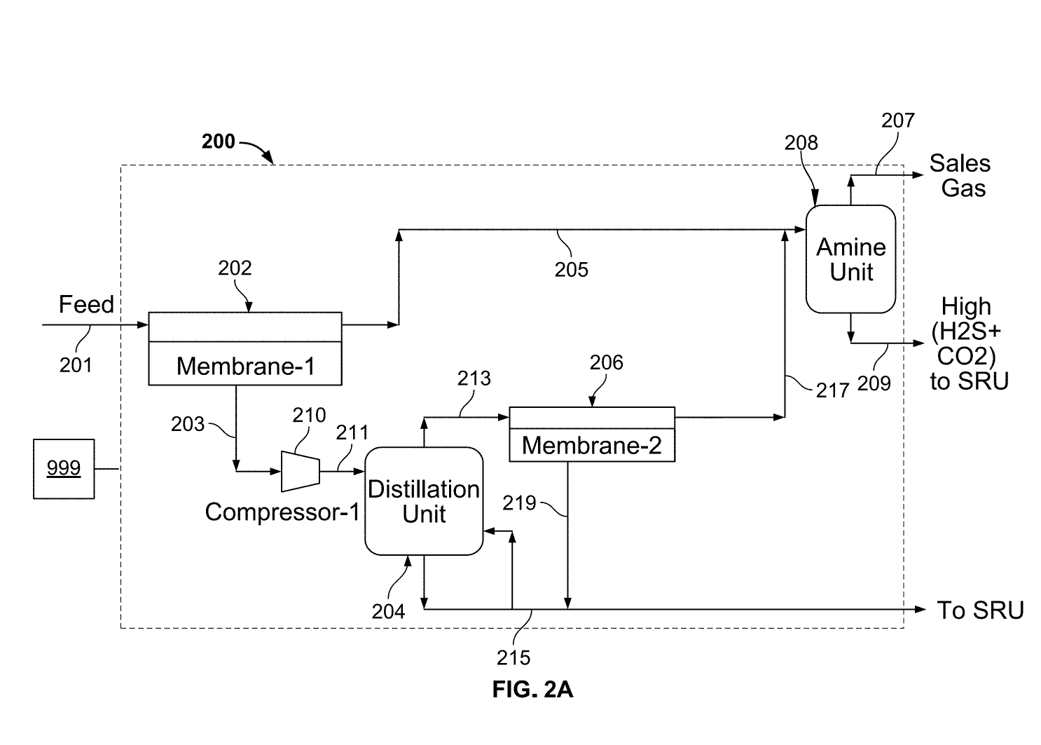

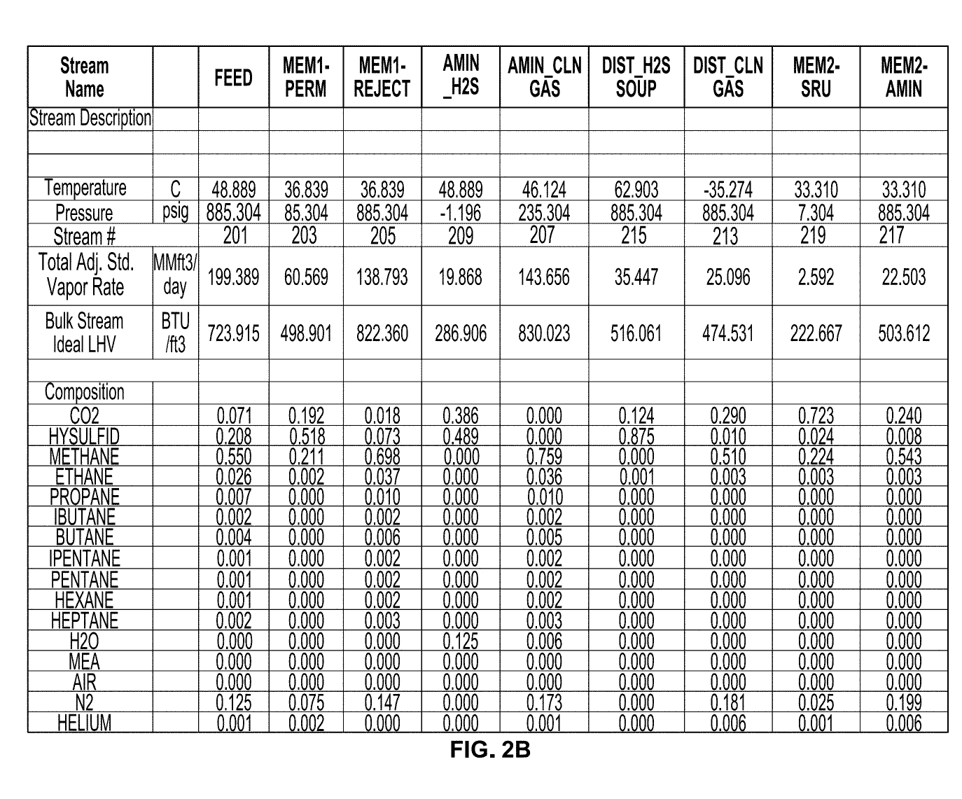

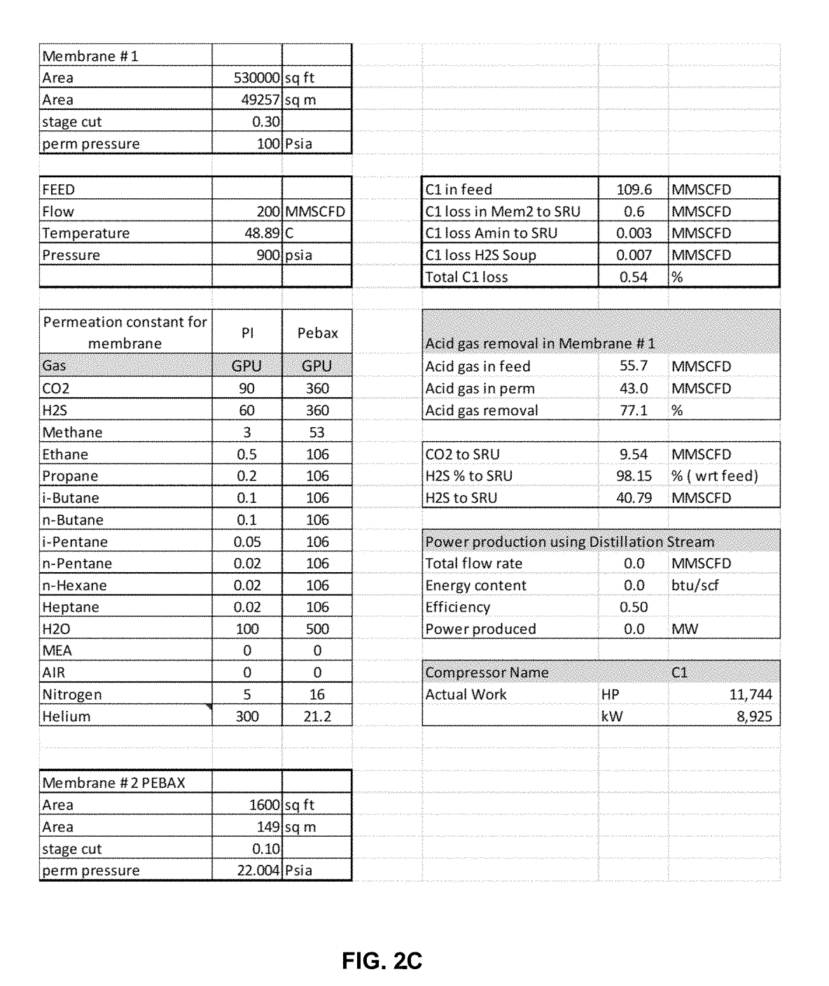

FIG. 2A shows a schematic illustration of another example implementation of a hybrid raw natural gas treatment system 200 that uses two membranes and a distillation unit to separate acid gases from natural gas. In this illustrated implementation, the system 200 includes a first membrane 202 that receives a raw natural gas feed stream 201. In some aspects, the natural gas feed stream 201 is at a flow rate of between 5 and 500 MMscfd. The first membrane 202 separates the natural gas feed stream 201 into a permeate stream 203 that flows through a compressor 210 to a distillation unit 204 and a reject stream 205 that flows to an amine unit 208. The permeate stream 203 has a relatively low concentration of HHC and a relatively high concentration of acid gases compared to the reject stream 205, which has a relatively low concentration of acid gases and a relatively high concentration of HHC. The first membrane 202 may be or include, for example, a PI membrane, a CA membrane, or a Hyflon AD-80 (amorphous perfluoropolymers) membrane. Thus, the first membrane 202 may be selected to ensure that acid gases (for example, H₂S and CO₂) are separated from HHC (for example, due to a material of the membrane 202).

The permeate stream 203, which may be at a lower pressure than the reject stream 205, is compressed into a compressed permeate stream 211 and circulated to the distillation unit 204, in which the acid gases (and possibly a small portion of HHC not separated in the first membrane 202) are separated in a bottom stream 215 of the distillation unit 204 from other gases (for example, He, H₂O and N₂) in an overhead stream 213 of the unit 204.

As illustrated, the system 200 includes a second membrane 206 fluidly coupled to the overhead stream 213 of the distillation unit 204. The second membrane 206 may be or include, for example, a PI membrane, a CA membrane, or a Hyflon AD-80 (amorphous perfluoropolymers) membrane. Thus, the second membrane 206 may also be selected to ensure that acid gases (for example, H₂S and CO₂) are separated from HHC (for example, due to a material of the second membrane 206). Thus, the second membrane 206 may further separate acid gases 219 from the overhead stream 213 (for example, from the He, H₂O, and N₂) and route the further separated acid gases 219 to the output of the bottom stream 215 of the distillation unit. The other gases 217 may be circulated to the amine unit 208 (to join the reject stream 205), while the acid gases from the distillation unit 204 and the second membrane 206 (and portion of HHC) may be circulated to the SRU.

The reject stream 205, which may be at a higher pressure than the permeate stream 203, is circulated to the amine unit 208, in which sales gas 207 is separated from the remaining acid gases 209 in the reject stream 205 (combined with the other gases 217). The separated acid gases 209 may also be circulated to the SRU. In some aspects, the sales gas 207 may be circulated to a refrigeration unit for recovery of the HHC.

FIGS. 2B-2C illustrate results of a simulation of the hybrid raw natural gas treatment system and process shown in FIG. 2A. FIGS. 2B-2C show simulations of the system 200 in which the first membrane 202 is an H₂S and CO₂ selective PI membrane and the second membrane 206 is an H₂S and CO₂ selective PEBAX membrane. FIGS. 2B-2C show simulations of the system 200 for mass balance (dry basis) as well as data regarding the membranes 202 and 206, permeation constant for the membrane 202, the acid gases removed by the membrane 202, and the power production using the overhead stream from distillation unit 204.

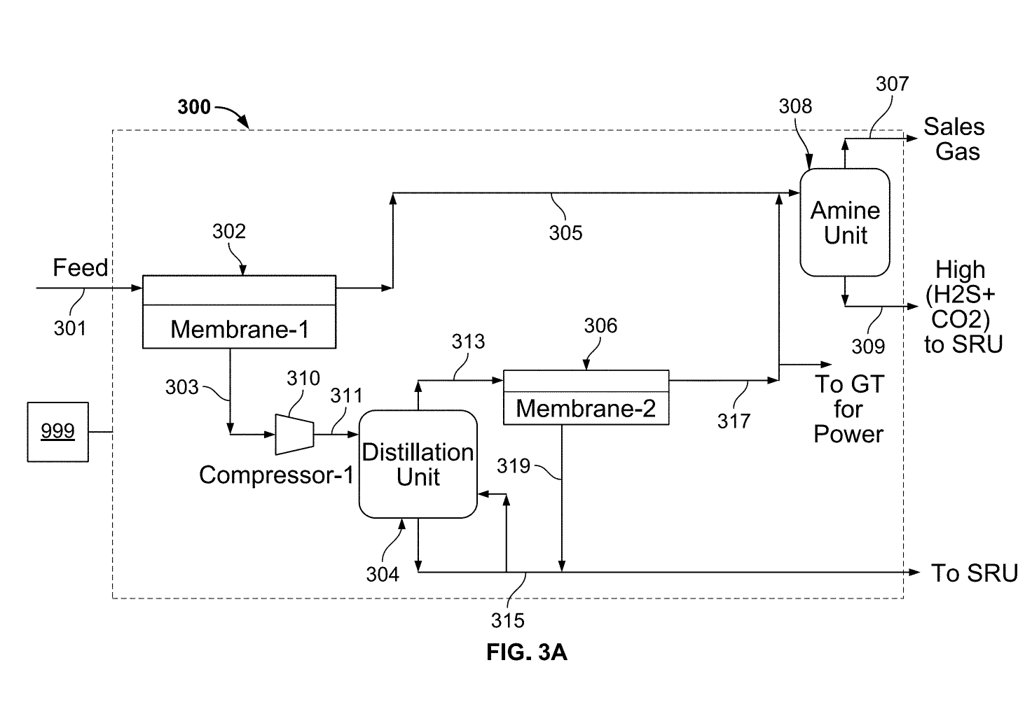

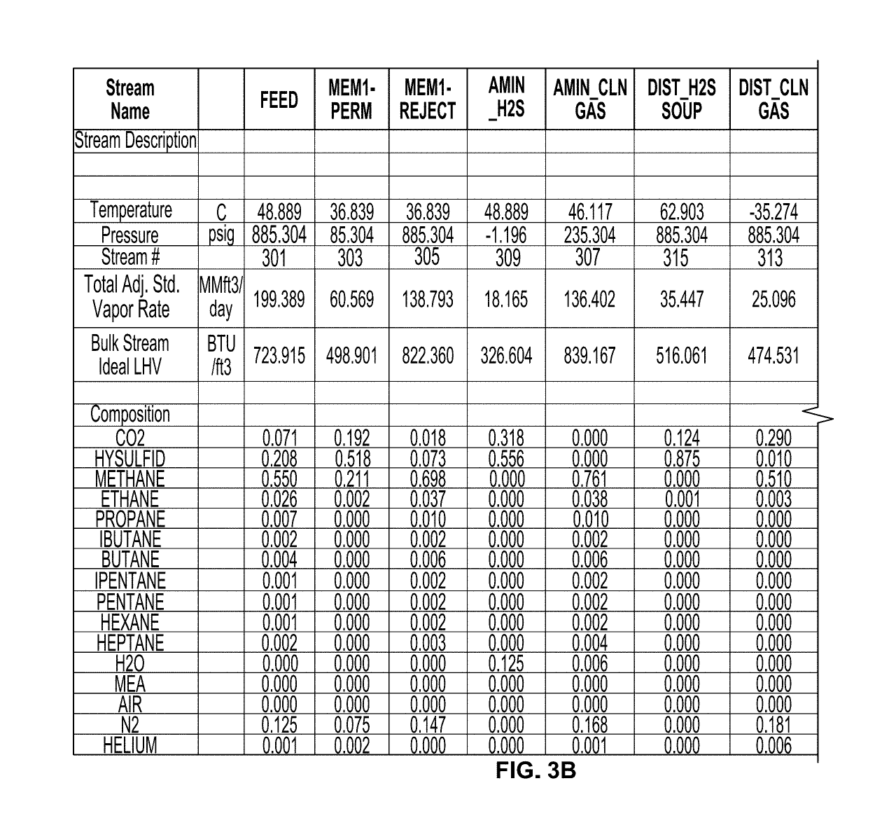

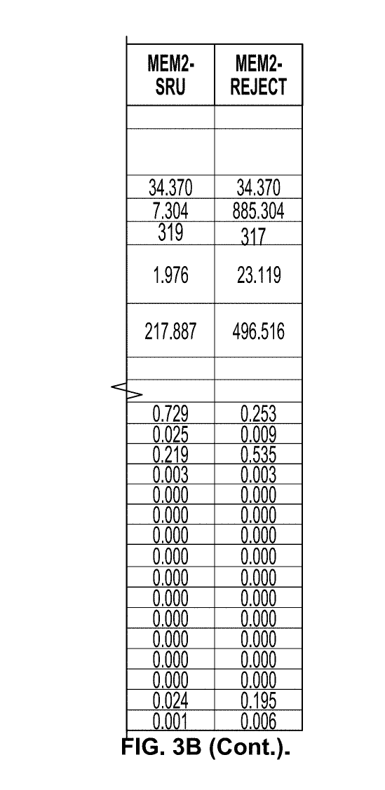

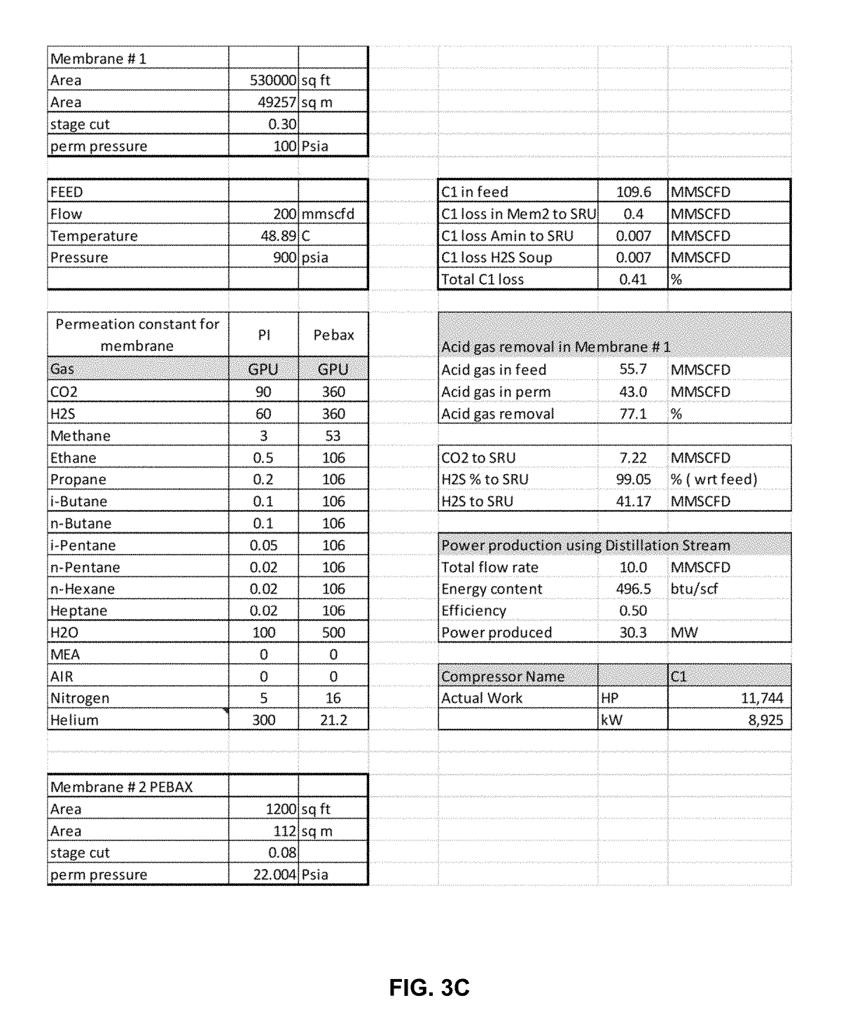

FIG. 3A shows a schematic illustration of another example implementation of a hybrid raw natural gas treatment system 300 that uses two membranes and a distillation unit to separate acid gases from natural gas. In this illustrated implementation, the system 300 includes a first membrane 302 that receives a raw natural gas feed stream 301. In some aspects, the natural gas feed stream 301 is at a flow rate of between 5 and 500 MMscfd. The first membrane 302 separates the natural gas feed stream 301 into a permeate stream 303 that flows through a compressor 310 to a distillation unit 304 and a reject stream 305 that flows to an amine unit 308. The permeate stream 303 has a relatively low concentration of HHC and a relatively high concentration of acid gases compared to the reject stream 305, which has a relatively low concentration of acid gases and a relatively high concentration of HHC. The first membrane 302 may be or include, for example, a PI membrane, a CA membrane, or a Hyflon AD-80 (amorphous perfluoropolymers) membrane. Thus, the first membrane 302 may be selected to ensure that acid gases (for example, H₂S and CO₂) are separated from HHC (for example, due to a material of the first membrane 302).

The permeate stream 303, which may be at a lower pressure than the reject stream 305, is compressed into a compressed permeate stream 311 and circulated to the distillation unit 304, in which the acid gases (and possibly a small portion of HHC not separated in the first membrane 302) are separated in a bottom stream 315 of the distillation unit 304 from other gases (for example, He, H₂O and N₂) in an overhead stream 313 of the unit 304.

As illustrated, the system 300 includes a second membrane 306 fluidly coupled to the overhead stream 313 of the distillation unit 304. The second membrane 306 may be or include, for example, a PI membrane, a CA membrane, or a Hyflon AD-80 (amorphous perfluoropolymers) membrane. Thus, the second membrane 306 may further separate acid gases 319 from the overhead stream 313 (for example, from the He, H₂O, and N₂) and route the further separated acid gases 319 to the output of the bottom stream 315 of the distillation unit. The other gases 317 may be circulated to the amine unit 308 or to the GT for power generation (or both), while the acid gases (combined 319 and 315) from the distillation unit 304 and the second membrane 306 (and portion of HHC) may be circulated to the SRU.

The reject stream 305, which may be at a higher pressure than the permeate stream 303, is circulated to the amine unit 308, in which sales gas 307 is separated from the remaining acid gases 309 in the reject stream 305. The separated acid gases 309 may also be circulated to the SRU. In some aspects, the sales gas 307 may be circulated to a refrigeration unit for recovery of the HHC.

FIGS. 3B-3C illustrate results of a simulation of the hybrid raw natural gas treatment system and process shown in FIG. 3A. FIGS. 3B-3C show simulations of the system 300 in which the first membrane 302 is an H₂S and CO₂ selective PI membrane and the second membrane 306 is an H₂S and CO₂ selective PEBAX membrane. FIGS. 3B-3C show simulations of the system 300 for mass balance (dry basis) as well as data regarding the membranes 302 and 306, permeation constant for the membrane 302, the acid gases removed by the membrane 302, and the power production using the other gases from the second membrane 306.

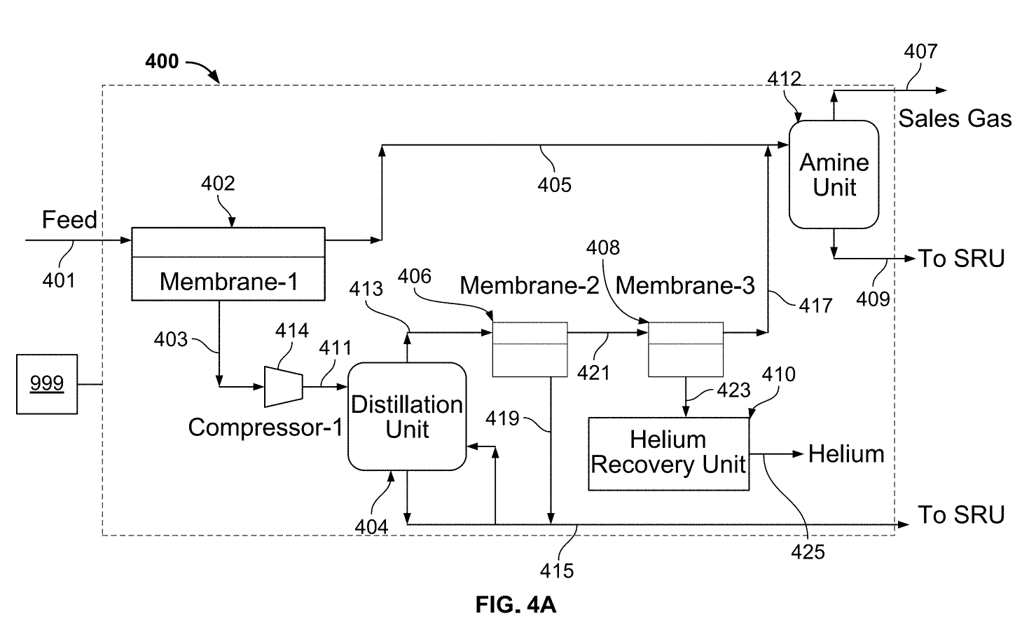

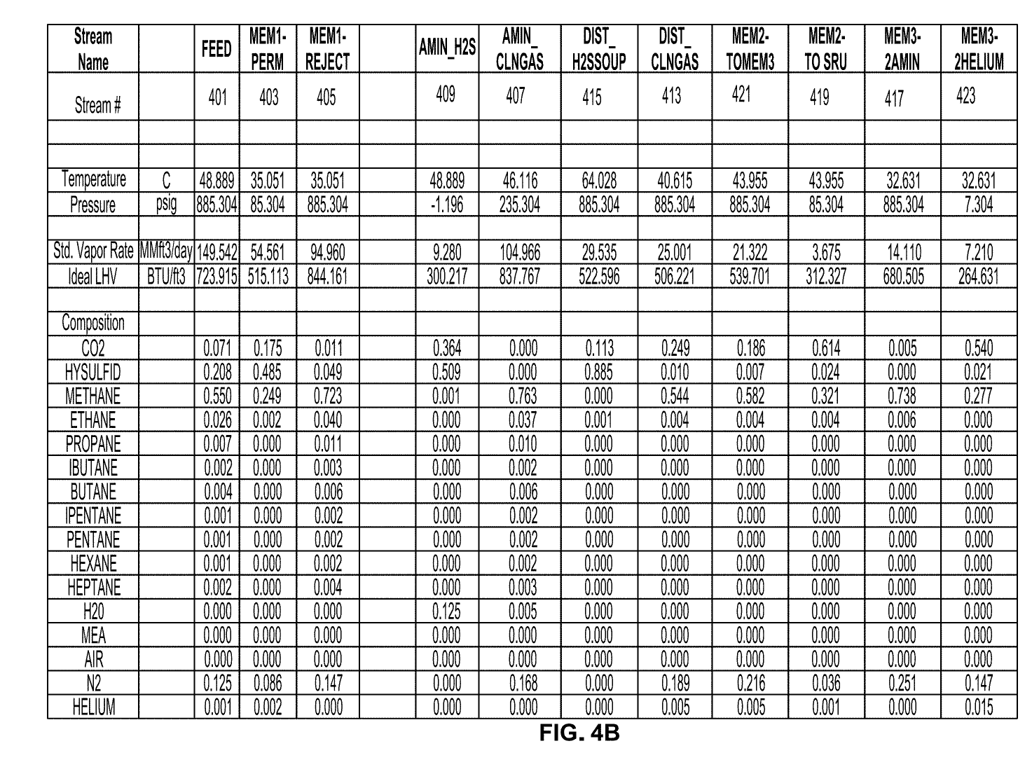

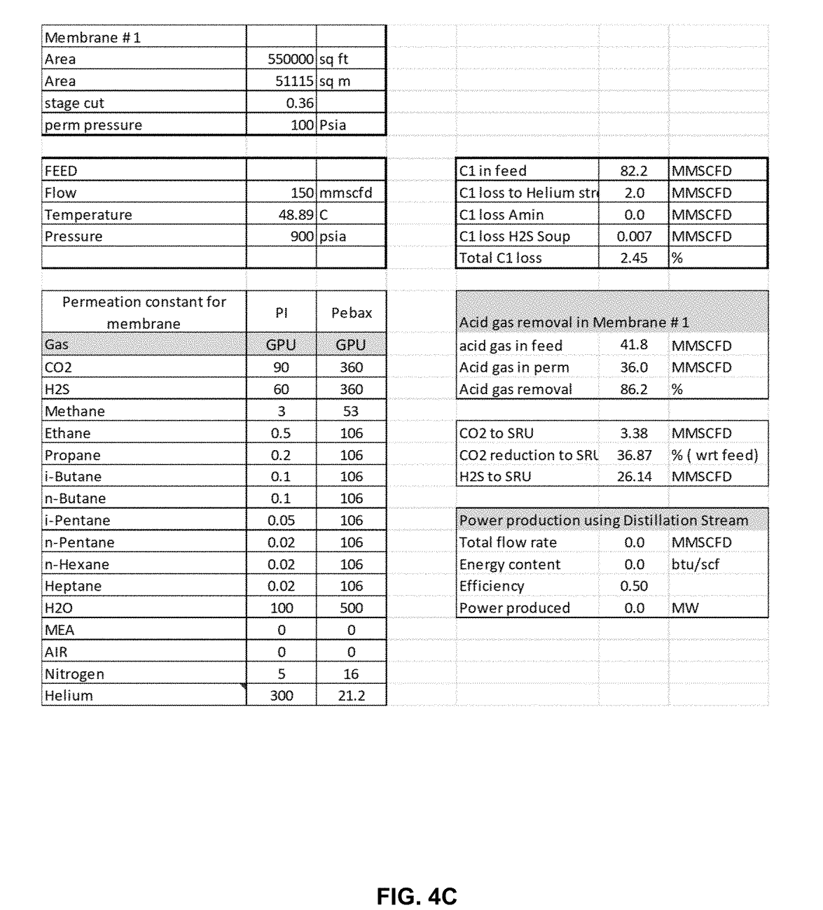

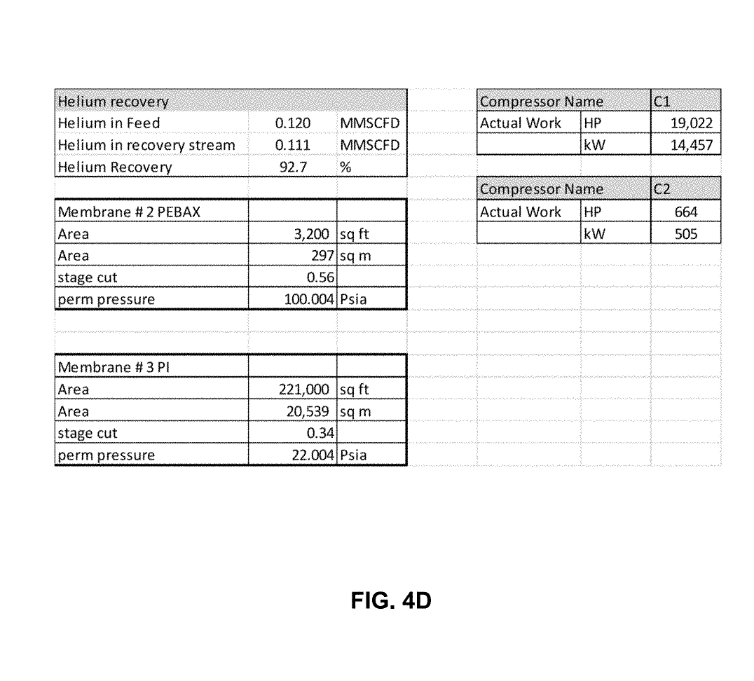

FIG. 4A shows a schematic illustration of another example implementation of a hybrid raw natural gas treatment system 400 that uses two membranes and a distillation unit to separate acid gases from natural gas, as well as a membrane and a helium recovery unit to capture helium from natural gas. In this illustrated implementation, the system 400 includes a first membrane 402 that receives a raw natural gas feed stream 401. In some aspects, the natural gas feed stream 401 is at a flow rate of between 5 and 500 MMscfd. The first membrane 402 separates the natural gas feed stream 401 into a permeate stream 403 that flows through a compressor 414 to a distillation unit 404 and a reject stream 405 that flows to an amine unit 412. The permeate stream 403 has a relatively low concentration of HHC and a relatively high concentration of acid gases compared to the reject stream 405, which has a relatively low concentration of acid gases and a relatively high concentration of HHC. The first membrane 402 may be or include, for example, a PI membrane, a CA membrane, or a Hyflon AD-80 (amorphous perfluoropolymers) membrane. Thus, the first membrane 402 may be selected to ensure that acid gases (for example, H₂S and CO₂) are separated from HHC (for example, due to a material of the first membrane 402).

The permeate stream 403, which may be at a lower pressure than the reject stream 405, is compressed into a compressed permeate stream 411 and circulated to the distillation unit 404, in which the acid gases (and possibly a small portion of HHC not separated in the first membrane 402) are separated in a bottom stream 415 of the distillation unit 404 from other gases (for example, He, H₂O and N₂) in an overhead stream 413 of the unit 404.

As illustrated, the system 400 includes a second membrane 406 fluidly coupled to the overhead stream 413 of the distillation unit 404. The second membrane 406 may be or include, for example, an H₂S and CO₂ selective PEBAX membrane. Thus, the second membrane 406 may further separate acid gases 419 from the overhead stream 413 (for example, from the He, H₂O and N₂) and route the further separated acid gases 419 to the output of the bottom stream 415 of the distillation unit 404.

In this example implementation, the other gases 421 may be circulated to a third membrane 408, in which helium (He) 423 is separated from the other gases 421 (for example, separated from H₂O, N₂). In this example, the third membrane 408 may be or include a PI helium selective membrane. The separated He 423 is routed to a helium recovery unit 410 from which the He 423 may be enriched for economic efficiencies into an enriched He stream 425.

The other gases 417 from which the He 423 is separated in the third membrane 408 may be routed from the third membrane 408 to the amine unit 412, while the acid gases (combined 415 and 419) from the distillation unit 404 and the second membrane 406 (and portion of HHC) may be circulated to the SRU. The reject stream 405, which may be at a higher pressure than the permeate stream 403, is circulated to the amine unit 412, in which sales gas 407 is separated from the remaining acid gases 409 in the combined reject stream 405 and gases stream 417. The separated acid gases 409 may also be circulated to the SRU. In some aspects, the sales gas 407 may be circulated to a refrigeration unit for recovery of the HHC.

FIGS. 4B-4D illustrate results of a simulation of the hybrid raw natural gas treatment system and process shown in FIG. 4A. FIGS. 4B-4D show simulations of the system 400 in which the first membrane 402 is an H₂S and CO₂ selective PI membrane, the second membrane 406 is an H₂S and CO₂ selective PEBAX membrane, and the third membrane is a PI helium selective membrane. FIGS. 4B-4D show simulations of the system 400 for mass balance (dry basis) as well as data regarding the membranes 402, 406, and 408, permeation constant for the membrane 402, and the acid gases removed by the membrane 402.

As further shown in FIG. 4C, power production using the distillation stream may be realized in the example implementations of the system 400. For example, although not specifically shown in FIG. 4A, the gases separated from the helium in the third membrane 408 may be routed to produce power.

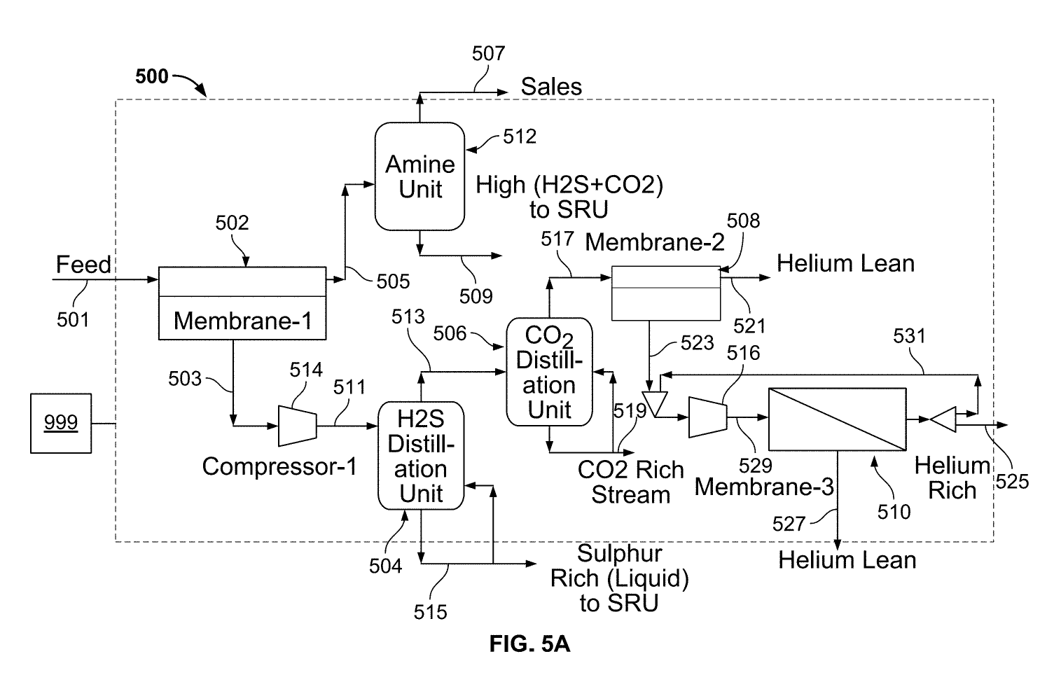

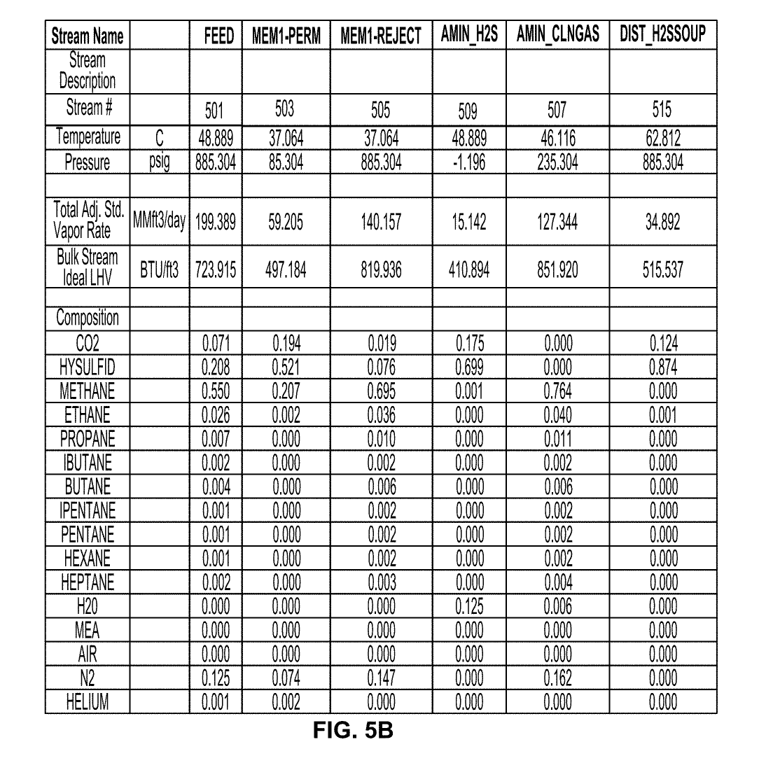

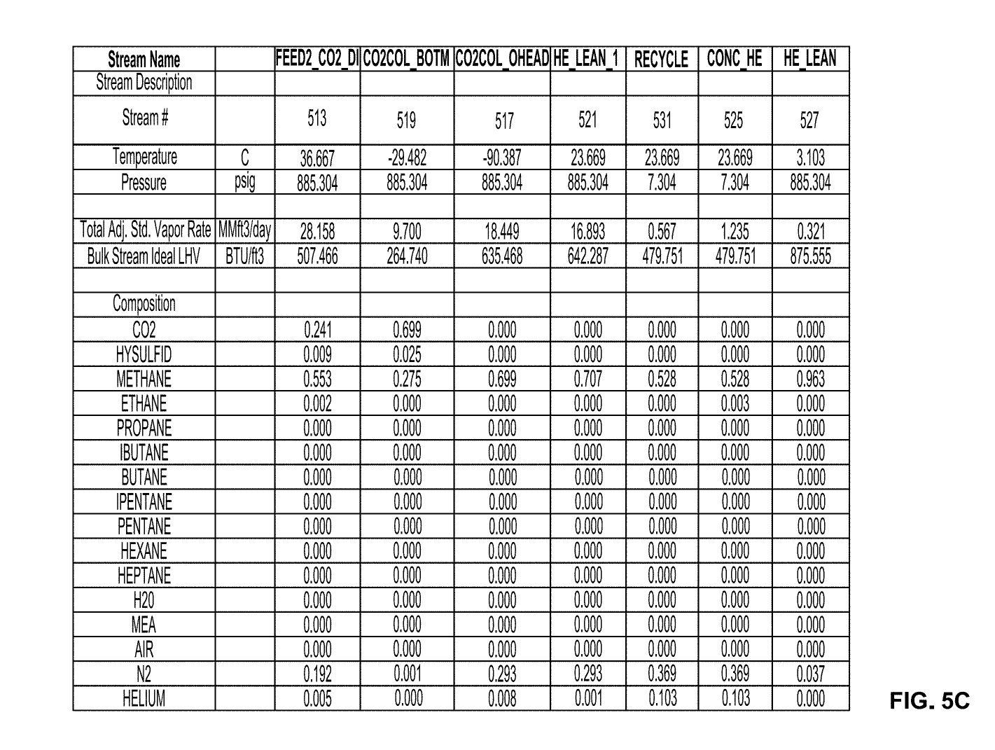

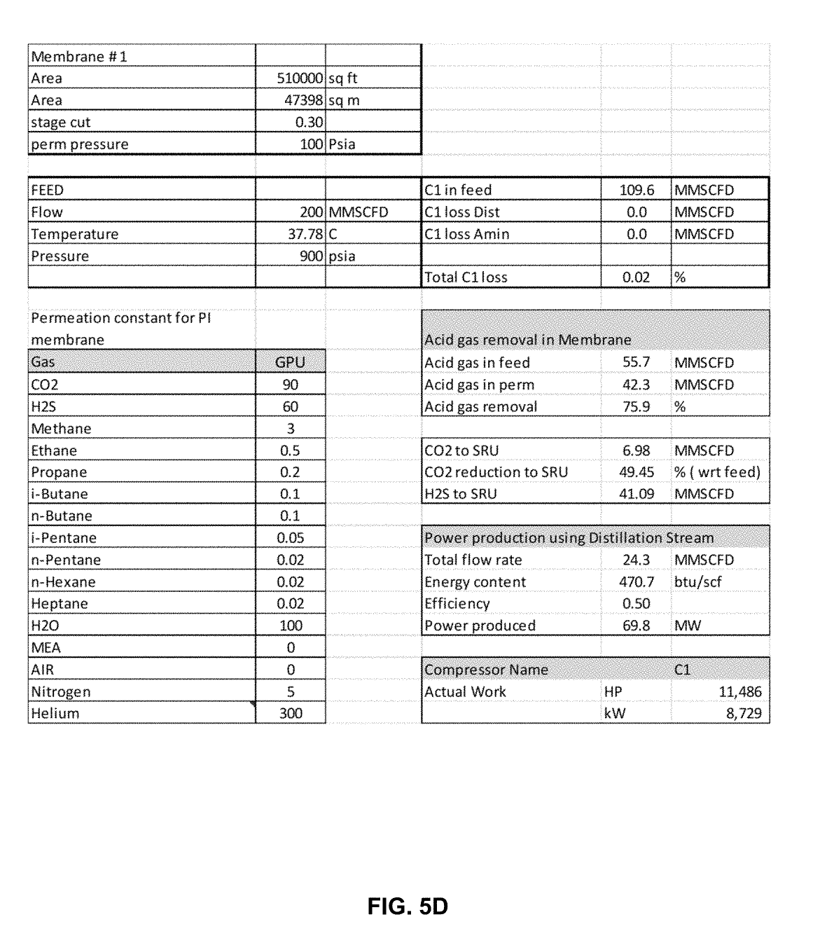

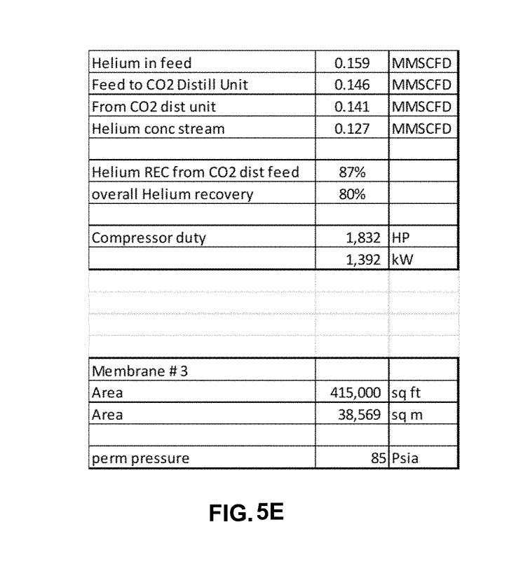

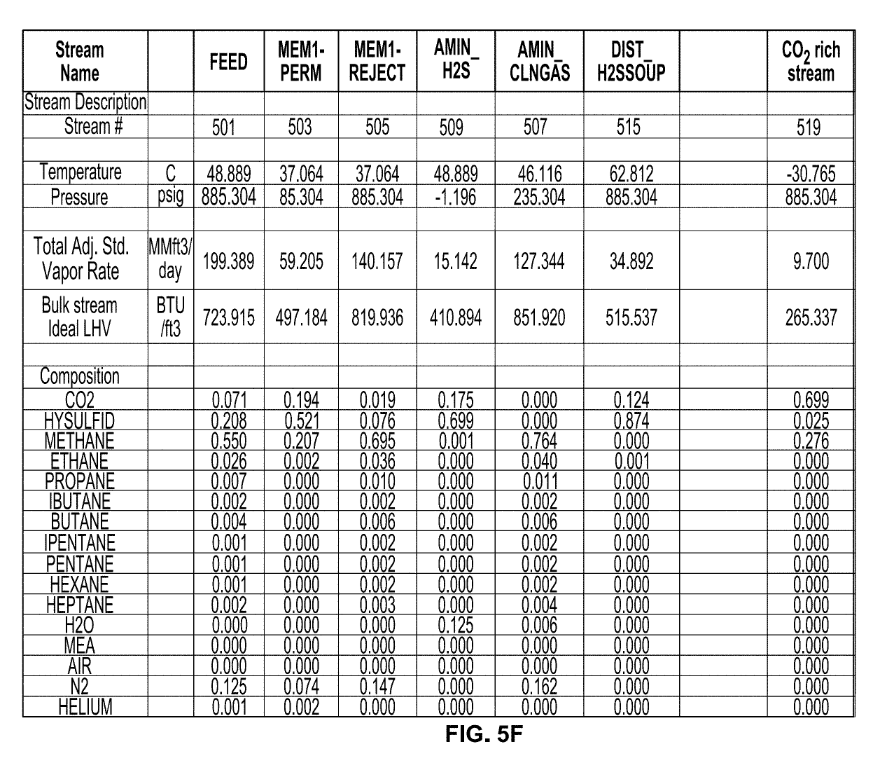

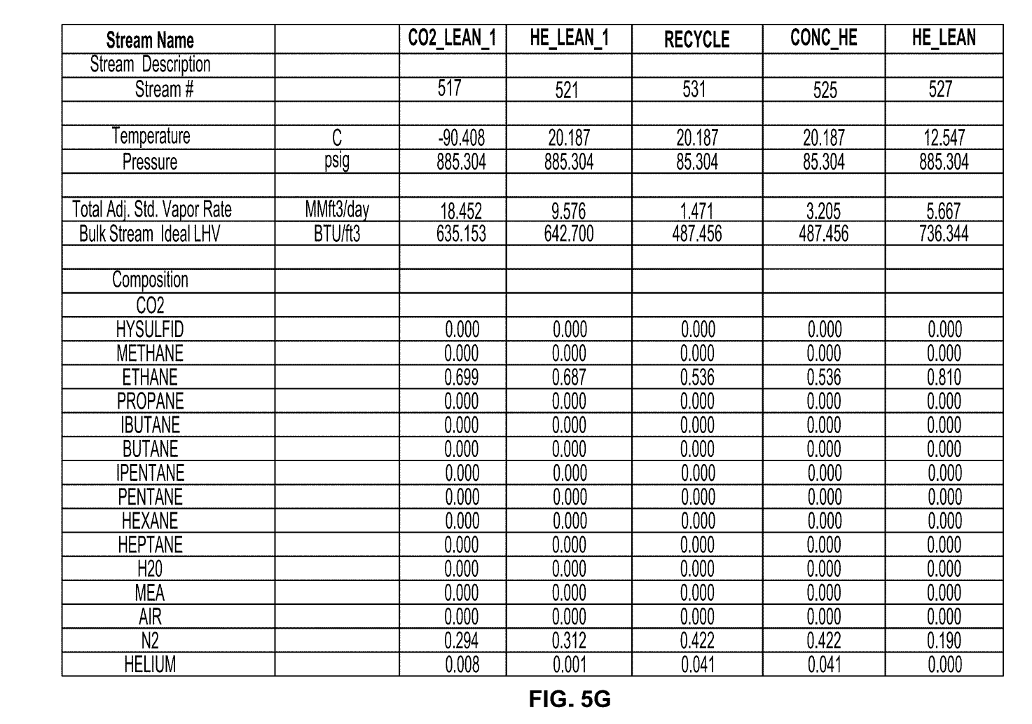

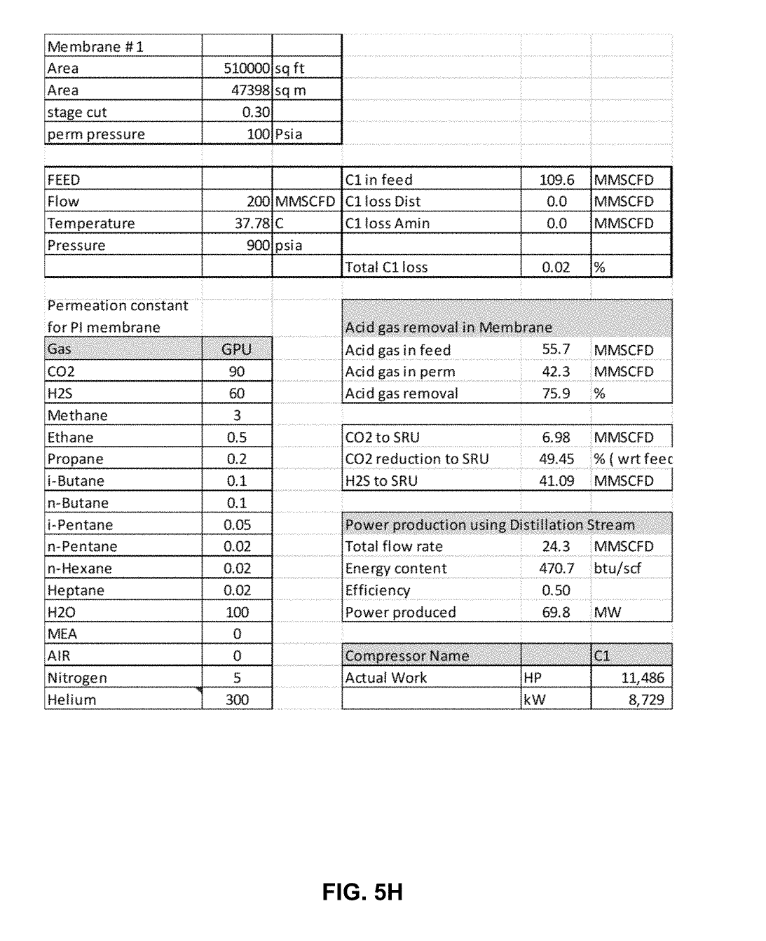

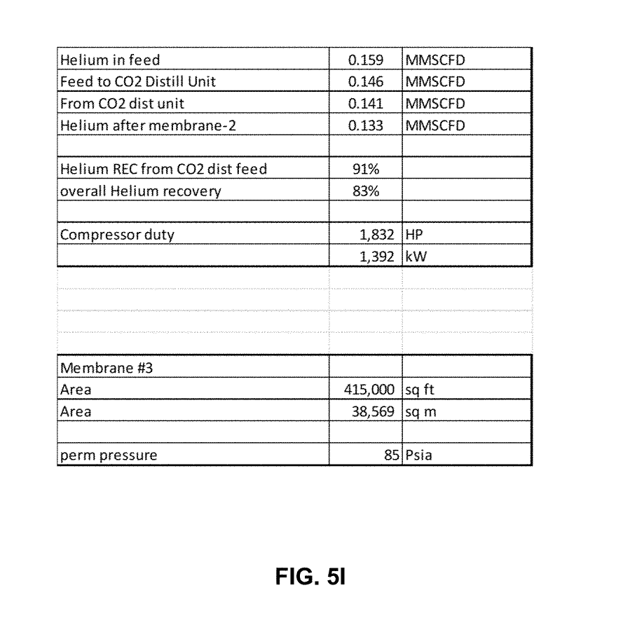

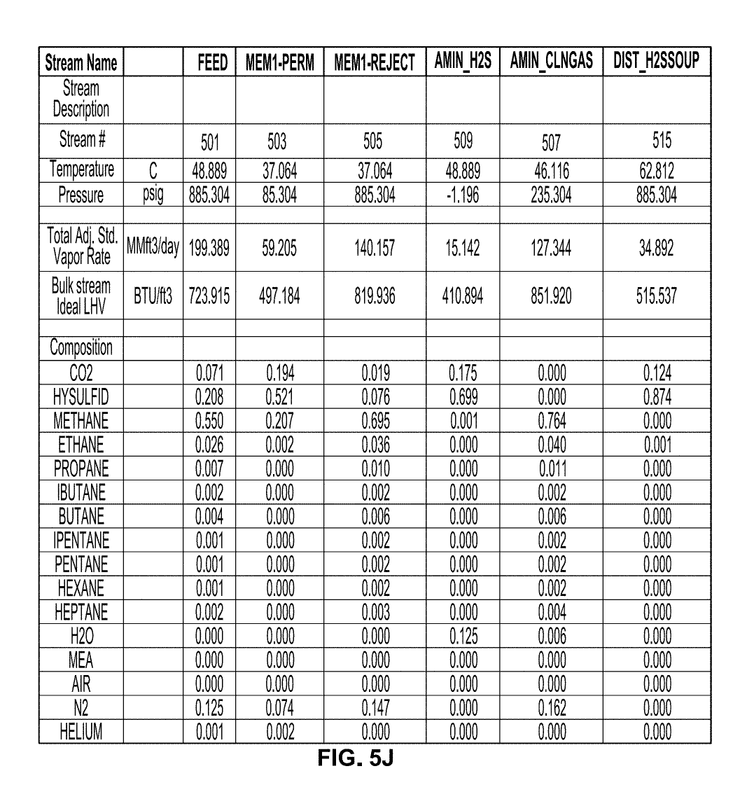

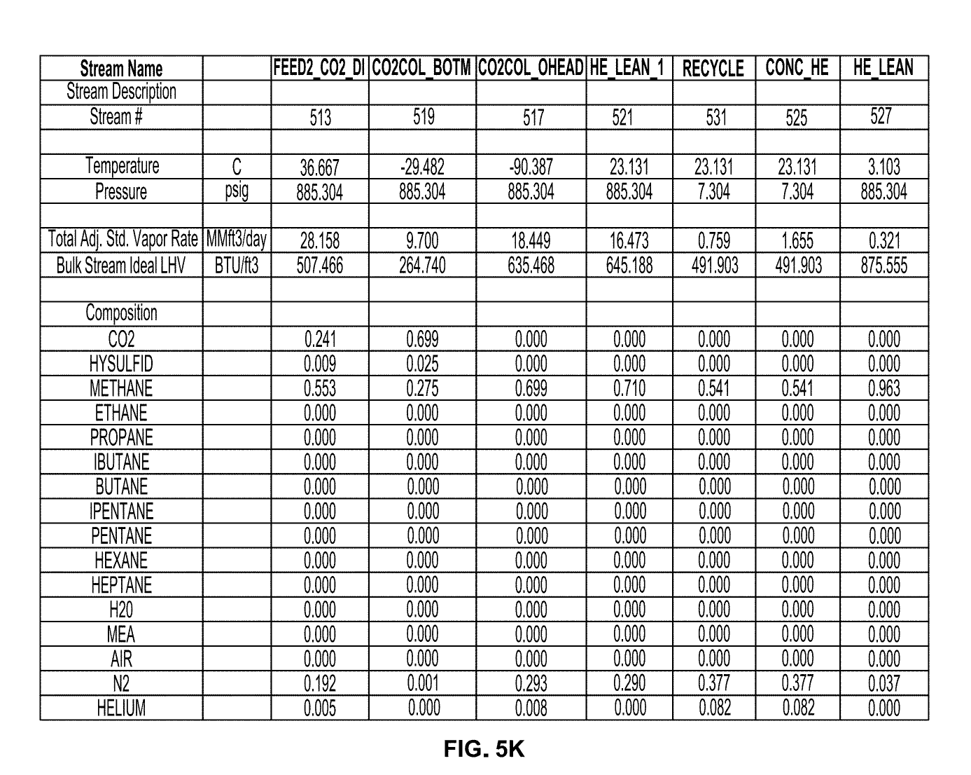

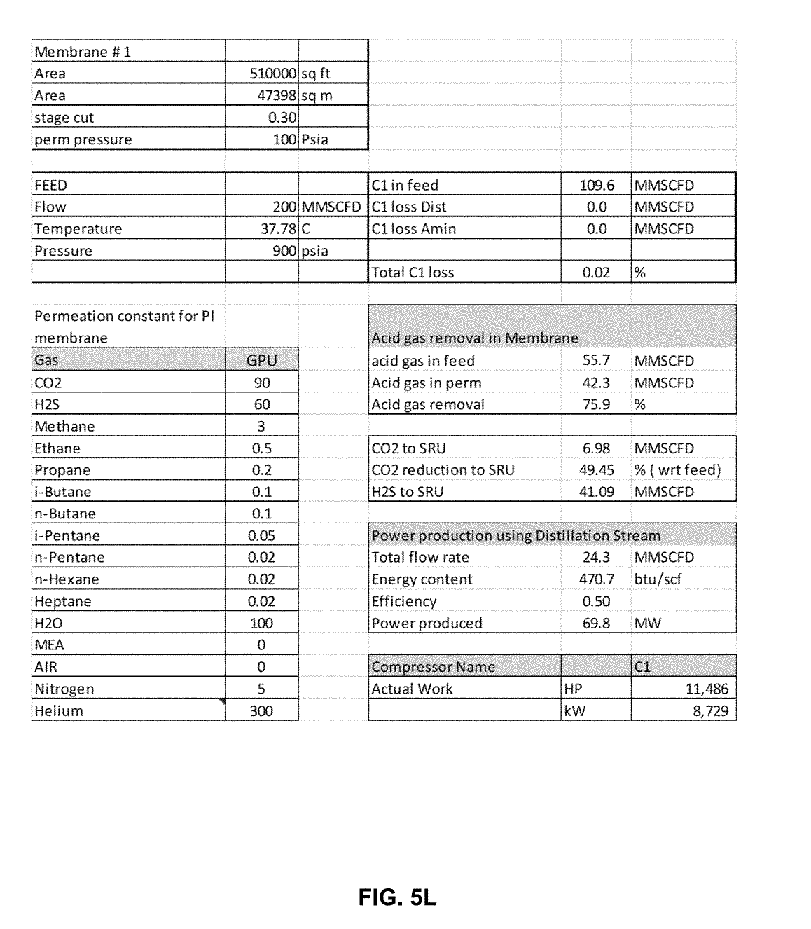

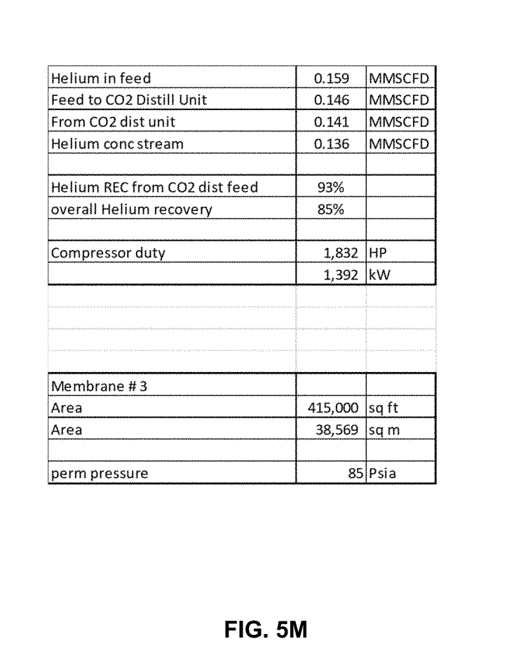

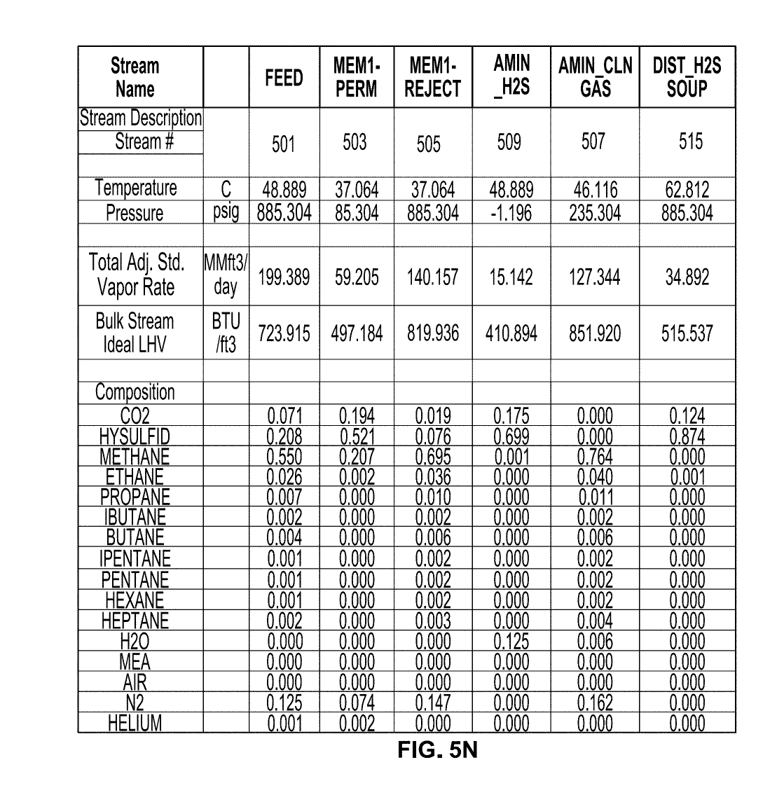

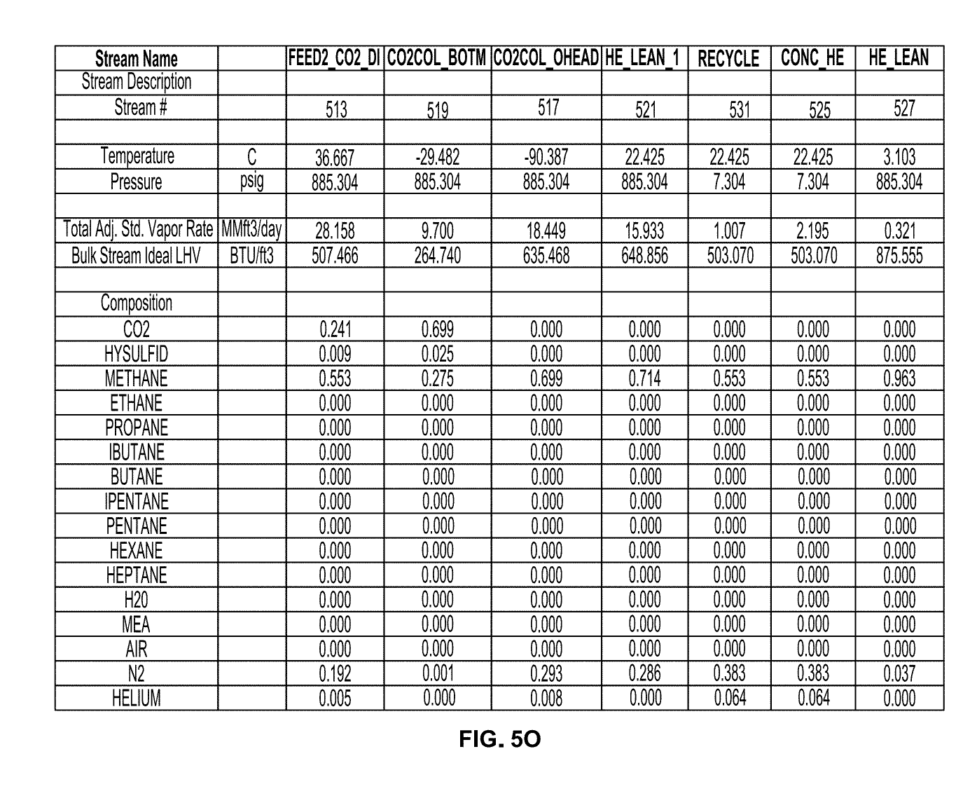

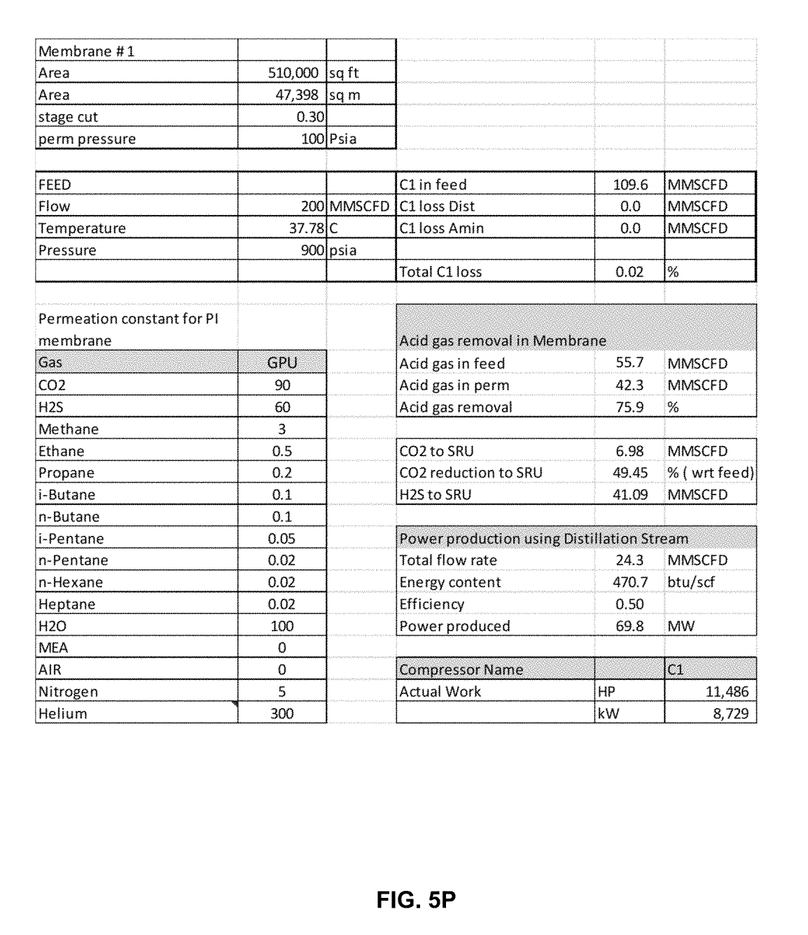

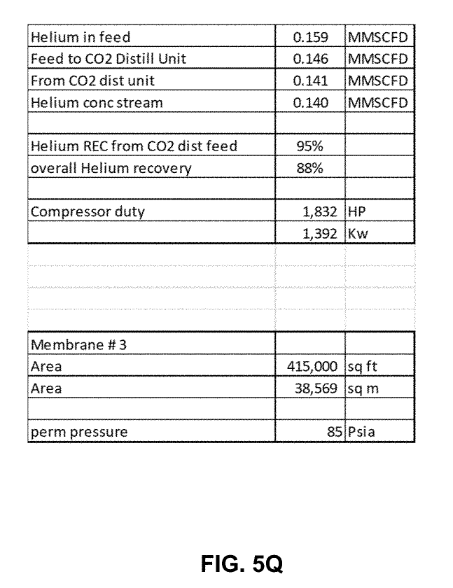

FIG. 5A shows a schematic illustration of another example implementation of a hybrid raw natural gas treatment system 500 that uses three membranes and two cascading distillation units to separate acid gases from natural gas and capture helium. In this illustrated implementation, the system 500 includes a first membrane 502 that receives a raw natural gas feed stream 501. In some aspects, the natural gas feed stream 501 is at a flow rate of between 5 and 500 MMscfd. The first membrane 502 separates the natural gas feed stream 501 into a permeate stream 503 that flows through a compressor 514 to a distillation unit 504 and a reject stream 505 that flows to an amine unit 512. The permeate stream 503 has a relatively low concentration of HHC and a relatively high concentration of acid gases compared to the reject stream 505, which has a relatively low concentration of acid gases and a relatively high concentration of HHC. The first membrane 502 may be or include, for example, a PI membrane, a CA membrane, or a Hyflon AD-80 (amorphous perfluoropolymers) membrane. Thus, the first membrane 502 may be selected to ensure that acid gases (for example, H₂S and CO₂) are separated from HHC (for example, due to a material of the first membrane 502).

The permeate stream 503, which may be at a lower pressure than the reject stream 505, is compressed and a compressed permeate stream 511 is circulated to the distillation unit 504. In this example, the distillation unit 504 is an H₂S selective distillation unit, in that H₂S is routed to a bottom stream 515 of the distillation unit 504 in an H₂S-rich stream, which is routed to the SRU. An overhead stream 513 of the distillation unit 504, which may contain acid and other gases, including CO₂, He, H₂O and N₂ (and is an H₂S-lean stream), is routed to distillation unit 506.

In this example, the distillation unit 506 is a CO₂ selective distillation unit, in that CO₂ is routed to the bottom stream 519 of the distillation unit 506 in a CO₂-rich stream. An overhead stream 517 of the distillation unit 506, which may contain other gases such as helium (He), H₂O and N₂ (and is a CO₂-lean stream), is routed to a second membrane 508. In this example, the second membrane 508 may be or include a PI helium selective membrane. The separated He 523 (in a He-rich stream) is routed through another compressor 516 and to a third membrane 510. A He-lean stream 521 is routed away from the second membrane 508 and may contain, for example, H₂O, N₂, and other gases.

In this example implementation, a compressed He-rich stream 529 is circulated to the third membrane 510. Like the second membrane 508, the third membrane 510 may be or include a PI helium selective membrane, which separates the incoming stream 529 from the second membrane 508 into a He-rich stream 531 (which can be enriched or recirculated to the third membrane 510) and a He-lean stream 525.

The reject stream 505, which may be at a higher pressure than the permeate stream 503, is circulated to the amine unit 512, in which sales gas 507 is separated from the remaining acid gases 509 in the reject stream 505. The separated acid gases 509 may be circulated to the SRU. In some aspects, the sales gas 507 may be circulated to a refrigeration unit for recovery of the HHC.

FIGS. 5B-5Q illustrate results of a simulation of the hybrid raw natural gas treatment system and process shown in FIG. 5A. FIGS. 5B-5Q show simulations of the system 500 in which the first membrane 502 is an H₂S and CO₂ selective membrane and the second and third membranes 508 and 510 are PI helium selective membranes. FIGS. 5B-5Q show simulations of the system 500 for mass balance (dry basis) as well as data regarding the membranes 502, 508, and 510, permeation constant for the membrane 502, and the acid gases removed by the membrane 502. More specifically, FIGS. 5B-5I illustrate an effect of permeate pressure on the third membrane helium stream (for example, FIGS. 5B-5E illustrate a low pressure and FIGS. 5F-5I illustrate a high pressure). FIGS. 5B-5I illustrate an effect of permeate pressure on the third membrane recycle stream (for example, FIGS. 5J-5M illustrate a low pressure and FIGS. 5N-5Q illustrate a high pressure).

As shown, each of systems 100, 200, 300, 400, and 500 includes a control system 999 that is communicably coupled (wired or wirelessly) to one or more components of the respective systems. Systems 100, 200, 300, 400, or 500 may be controlled (for example, control of temperature, pressure, flowrates of fluid, or a combination of such parameters) to provide for a desired output given particular inputs. In some aspects, a flow control system for systems 100, 200, 300, 400, or 500 can be operated manually. For example, an operator can set a flow rate for a pump or transfer device and set valve open or close positions to regulate the flow of the process streams through the pipes in the flow control system. Once the operator has set the flow rates and the valve open or close positions for all flow control systems distributed across the system, the flow control system can flow the streams under constant flow conditions, for example, constant volumetric rate or other flow conditions. To change the flow conditions, the operator can manually operate the flow control system, for example, by changing the pump flow rate or the valve open or close position.

In some aspects, a flow control system for systems 100, 200, 300, 400, and 500 can be operated automatically. For example, control system 999 is communicably coupled to the components and sub-systems of systems 100, 200, 300, 400, and 500. The control system 999 can include or be connected to a computer or control system to operate systems 100, 200, 300, 400, and 500. The control system 999 can include a computer-readable medium storing instructions (such as flow control instructions and other instructions) executable by one or more system and processors to perform operations (such as flow control operations). An operator can set the flow rates and the valve open or close positions for all flow control systems distributed across the facility using the control system 999. In such embodiments, the operator can manually change the flow conditions by providing inputs through the control system 999. Also, in such embodiments, the control system 999 can automatically (that is, without manual intervention) control one or more of the flow control systems, for example, using feedback systems connected to the control system 999. For example, a sensor (such as a pressure sensor, temperature sensor or other sensor) can be connected to a pipe through which a process stream flows. The sensor can monitor and provide a flow condition (such as a pressure, temperature, or other flow condition) of the process stream to the control system 999. In response to the flow condition exceeding a threshold (such as a threshold pressure value, a threshold temperature value, or other threshold value), the control system 999 can automatically perform operations. For example, if the pressure or temperature in the pipe exceeds the threshold pressure value or the threshold temperature value, respectively, the control system 999 can provide a signal to the pump to decrease a flow rate, a signal to open a valve to relieve the pressure, a signal to shut down process stream flow, or other signals.

Control system 999 can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A method of treating a natural gas feed stream, comprising:
receiving a natural gas feed stream that comprises one or more acid gases, one or more hydrocarbon fluids, and one or more non-hydrocarbon fluids;
circulating the natural gas feed stream to a membrane module;
separating, with the membrane module, at least a portion of the one or more acid gases into a permeate stream and at least a portion of the one or more hydrocarbon fluids into a reject stream;
circulating the permeate stream to a distillation unit; and
separating, in the distillation unit, the one or more acid gases from the one or more non-hydrocarbon fluids.

2. The method of claim 1, further comprising:
circulating the permeate stream through a compressor fluidly positioned between the membrane module and the distillation unit; and
circulating the reject stream to an amine unit.

3. The method of claim 1, further comprising:
separating the one or more hydrocarbon fluids in the reject stream from another portion of the one or more acid gases in the amine unit; and
circulating the one or more hydrocarbon fluids to a sales gas pipeline, and circulating the other portion of the one or more acid gases to a sulfur recovery unit (SRU).

4. The method of claim 1, wherein the membrane module comprises an acid gas selective membrane that comprises at least one of a poly-imide (PI) membrane, a cellulose acetate (CA) membrane, or an amorphous perfluoropolymer membrane.

5. The method of claim 1, wherein the distillation unit comprises a bottom output that outputs the portion of the one or more acid gases and an overhead output that outputs the one or more non-hydrocarbon fluids, the method further comprising:
circulating the one or more non-hydrocarbon fluids to a power generation unit, and circulating the portion of the one or more acid gases to the SRU; and
circulating the one or more non-hydrocarbon fluids to a second membrane module fluidly coupled between the overhead output and the amine unit.

6. The method of claim 5, wherein the second membrane module comprises another acid gas selective membrane that comprises at least one of a PI membrane, a CA membrane, or an amorphous perfluoropolymer membrane.

7. The method of claim 5, further comprising:
separating, with the second membrane module, another portion of the one or more acid gases entrained in the one or more non-hydrocarbon fluids;
circulating the separated portion of the one or more acid gases to the SRU, and circulating the one or more non-hydrocarbon fluids to at least one of the amine unit or the power generation unit; and
circulating the separated one or more non-hydrocarbon fluids to a third membrane module.

8. The method of claim 7, wherein the third membrane module comprises a helium selective membrane that comprises a PI helium selective membrane.

9. The method of claim 8, further comprising:
separating a helium fluid from the one or more non-hydrocarbon fluids with the third membrane module; and
recovering the separated helium fluid in a helium recovery unit that is fluidly coupled to the third membrane module.

10. The method of claim 1, wherein the distillation unit comprises a hydrogen sulfide (H₂S) distillation unit, the method further comprising:
separating, in the H₂S distillation unit, a stream of H₂S from the one or more acid gases; and
circulating the stream of H₂S to the SRU, and circulating an H₂S-lean stream of the one or more acid gases to another distillation unit.

11. The method of claim 10, wherein the other distillation unit comprises a carbon dioxide (CO₂) distillation unit.

12. The method of claim 11, further comprising:
separating, in the other distillation unit, a stream of CO₂ from the H₂S-lean stream;
circulating the stream of CO₂ away from the other distillation unit, and circulating a CO₂-lean stream from the other distillation unit to a second membrane module;
separating, in the second membrane module, at least a portion of a helium fluid from the CO₂-lean stream;
circulating the portion of the helium fluid to a third membrane module, and circulating a helium-lean stream from the second membrane module; and
separating another portion of the helium fluid, in the third membrane module.

13. The method of claim 1, wherein the one or more acid gases comprises at least one of H₂S or CO₂.

14. A natural gas processing system, comprising:
a first membrane module positioned to receive a natural gas feed stream that comprises one or more acid gases, one or more hydrocarbon fluids, and one or more non-hydrocarbon fluids, the first membrane module configured to separate at least a portion of the one or more acid gases into a permeate stream and at least a portion of the one or more hydrocarbon fluids into a reject stream;
a distillation unit in fluid communication with the first membrane; and
a control system configured to perform operations comprising:
circulating the natural gas feed stream to the first membrane module;
circulating the permeate stream separated by the first membrane module to the distillation unit; and
operating the distillation unit to separate, in the distillation unit, the one or more acid gases from the one or more non-hydrocarbon fluids.

15. The natural gas processing system of claim 14, wherein the control system is configured to perform operations further comprising:
circulating the permeate stream through a compressor fluidly positioned between the membrane module and the distillation unit; and
circulating the reject stream to an amine unit.

16. The natural gas processing system of claim 14, wherein the control system is configured to perform operations further comprising:
separating the one or more hydrocarbon fluids in the reject stream from another portion of the one or more acid gases in the amine unit;
circulating the one or more hydrocarbon fluids to a sales gas pipeline; and
circulating the other portion of the one or more acid gases to a sulfur recovery unit (SRU).

17. The natural gas processing system of claim 14, wherein the first membrane module comprises an acid gas selective membrane that comprises at least one of a poly-imide (PI) membrane, a cellulose acetate (CA) membrane, or an amorphous perfluoropolymer membrane.

18. The natural gas processing system of claim 14, wherein the distillation unit comprises a bottom output and an overhead output, the control system configured to perform operations further comprising:
circulating the portion of the one or more acid gases from the bottom output;
circulating the one or more non-hydrocarbon fluids from the overhead output;
circulating the one or more non-hydrocarbon fluids to a power generation unit;
circulating the portion of the one or more acid gases to the SRU; and
circulating the one or more non-hydrocarbon fluids to a second membrane module fluidly coupled between the overhead output and the amine unit.

19. The natural gas processing system of claim 18, wherein the second membrane module comprises another acid gas selective membrane that comprises at least one of a PI membrane, a CA membrane, or an amorphous perfluoropolymer membrane.

20. The natural gas processing system of claim 18, wherein the control system is configured to perform operations further comprising:
operating the second membrane module to separate another portion of the one or more acid gases entrained in the one or more non-hydrocarbon fluids;
circulating the separated portion of the one or more acid gases to the SRU;
circulating the one or more non-hydrocarbon fluids to at least one of the amine unit or the power generation unit; and
circulating the separated one or more non-hydrocarbon fluids to a third membrane module.

21. The natural gas processing system of claim 20, wherein the third membrane module comprises a helium selective membrane that comprises a PI helium selective membrane.

22. The natural gas processing system of claim 21, wherein the control system is configured to perform operations further comprising:
operating the third membrane module to separate a helium fluid from the one or more non-hydrocarbon fluids with the third membrane module; and
recovering the separated helium fluid in a helium recovery unit that is fluidly coupled to the third membrane module.

23. The natural gas processing system of claim 14, wherein the distillation unit comprises a hydrogen sulfide (H₂S) distillation unit, the control system configured to perform operations further comprising:
operating the H₂S distillation unit to separate a stream of H₂S from the one or more acid gases;
circulating the stream of H₂S to the SRU; and
circulating an H₂S-lean stream of the one or more acid gases to another distillation unit.

24. The natural gas processing system of claim 23, wherein the other distillation unit comprises a carbon dioxide (CO₂) distillation unit.

25. The natural gas processing system of claim 24, wherein the control system is configured to perform operations further comprising:
operating the other distillation unit to separate a stream of CO₂ from the H₂S-lean stream;
circulating the stream of CO₂ away from the other distillation unit;
circulating a CO₂-lean stream from the other distillation unit to the second membrane module;
operating a second membrane module to separate at least a portion of a helium fluid from the CO₂-lean stream;
circulating the portion of the helium fluid to a third membrane module;
circulating a helium-lean stream from the second membrane module; and
operating the third membrane module to separate another portion of the helium fluid.

26. The natural gas processing system of claim 14, wherein the one or more acid gases comprises at least one of H₂S or CO₂.
